(19) United States
(12) Patent Application Publication
(10) Pub. No.: US 2005/0038812 A1
(43) Pub. Date: Feb. 17, 2005

(54) Method and apparatus for managing data

(76) Inventors: Thomas M. Tirpak, Glenview, IL (US); John S. Graettinger, Wilmette, IL (US); Michael S. Kramer, Lake Bluff, IL (US); Vincent W. Petraroli, Libertyville, IL (US); Linda R. Rodda, Algonquin, IL (US); Weimin Xiao, Hoffman Estates, IL (US)

Correspondence Address: VEDDER PRICE KAUFMAN & KAMMHOLZ, 222 N. LASALLE STREET, CHICAGO, IL, 60601, US

(21) Appl. No.: 10/637,905

(22) Filed: Aug. 11, 2003

(51) Int. Cl. G06F 17/00

(52) U.S. Cl. 707/104.1

(57) ABSTRACT

A data management system (100) including a knowledge container creator module (118) operative to create at least a first data descriptor item (112) and at least a second data descriptor item (114) based upon a raw data item (110). The raw data item (110) is capable of containing data representing raw data that is in one of a plurality of different formats. The knowledge container creator module (118) also operative to link the raw data item (110) to at the least a first data descriptor item (112) and to link the raw data item (110) to the at least a second data descriptor item (114).

### FIELD OF THE INVENTION

The invention relates generally to the storage, retrieval and manipulation of related data, and more particularly, to methods and apparatus for storage, retrieval and the manipulation of related data associated with information gathering systems.

### BACKGROUND OF THE INVENTION

Currently, entities who are in the business of designing and manufacturing new products are faced with significant resource expenditures related to the testing of such products, including the storage, retrieval and the manipulation of the data developed during the testing of such products. It is not uncommon for such entities to use off-the-shelf data acquisition systems that provide an interface to analog/digital outputs from measurement equipment, a means to perform statistical analyses on the acquired measurements, and a graphical user interface by which it is possible to view the results and manually enter additional information. In situations where there is no direct interface to the measurement equipment, it is not uncommon to use web forms or database forms to provide the user the means to store the measurements. Web forms are a part of the Hypertext Markup Language (HTML) standard. Common Gateway Interface (CGI) scripts are typically used to interpret such web forms and provide a method for data input to a centralized system. Likewise, most commercially available database systems include an environment for developing graphical user interfaces for inputting data and querying the database. One example is Oracle's Oracle Forms™. However, such systems can have significant limitations. For example, although they can be used as an effective repository of text and binary computer files generated by measurement equipment, such systems may capture only a very limited amount of context knowledge about the testing data, for example, date, user name, product and other project management related information. It is recognized by practitioners in the field of Knowledge Management, that data without sufficient context knowledge is of very limited value to decision makers. Such systems typically provide only rudimentary methods for searching of data captured. Thus, it is often difficult to find applicable knowledge in the database, since the data are keyword-searchable in broad groups rather than in specific categories, as determined by the context in which the data were originally created. Other limitations of such systems are known to be their limited functionality including their inability to be easily reconfigured once designed and released for use, for example, it is often difficult to add or remove new or existing fields.

Generally, data management systems currently used to record testing data are maintained at a local client station, i.e., either attached to or adjacent to the measurement equipment that generated them, and are otherwise not generally available outside the lab that generated the results. Often, the fact that a data management system is based on stand-alone personal computers (PCs) is a significant factor in isolating the results, as only those with access to the PC have access to the results stored therein. Also, the lack of a common database is also often a factor. Other factors isolating the data include those situations where users are either unaware of the information, do not know how to access the information, or are otherwise restricted from its access by a variety of either physical and/or computer related design issues. Such isolation of the testing data also tends to perpetuate isolation of individual product development teams as each maintains and uses only its own testing data. Further, this isolation often results in the same tests being performed by multiple groups, simply because those in need of such information had no means to know about the prior test results. Such repetitive testing results in unnecessary costs being incurred by the entity.

Although test data are not typically stored in large databases accessible by a variety of users, as described above, other systems storing other data are known to be stored in such large databases. Examples of such databases are Microsoft Access™, Microsoft SQL Server™, or other databases offered by database providers Oracle and Sybase. However such systems do not typically provide a unified representation for knowledge including raw test data items containing the results of individual tests, for example, a digital image file showing a product test, metaknowledge (which is commonly defined as “knowledge about knowledge,”) containing knowledge about the raw test data items, for example keywords associated with the digital image file stored as a raw test data item, and/or knowledge transformation information containing information extrapolated from the raw test data items.

In addition, methods for searching data stored in large databases are also generally known. Examples of existing tools used to search such databases include database queries, Boolean search strings, and category-based searching such as that found on www.northernlight.com. However, such tools are generally absent an effective method for sharing common templates used to universally define and maintain searches by category and by keyword. Absent such templates such systems also do not typically dynamically reconfigure the user interface for the search engine using such shared common templates

Also, typically for the same reasons that testing data is not generally stored in large databases as discussed above, the need for further manipulating large quantities of testing data has also not generally been needed. However, for those systems which have benefited from their placement into large databases, a number have employed the use of metaknowledge to assist users in better taking advantage of the useful information contained therein. The Extensible Markup Language (XML), which provides a convenient representation for metaknowledge via a set of “tags” defined in a shared Data Type Dictionary (DTD) for a given organizational entity, is commonly known. Current systems for Data Mining and Text Mining can be used to identify “tags” which can be added to the source data in XML format. There are many commercial and research tools available for text mining, including Information Discovery's Data Mining Suite™. However, such systems, as they exist today, do not provide for the specific vocabulary likely needed for the use with test data. Neither do they integrate the raw data, the collected metaknowledge describing the context of the testing, the automatically generated metaknowledge (“tags”) in the data set, links to additional data, and a model describing the validity/applicability of the knowledge to specific scenarios, within a single knowledge representation that is understandable by multiple computer/human systems. In short, current systems do not provide an adequately structured method or knowledge representation to ensure that old test data can remain useful for users in the future.

### BRIEF DESCRIPTION OF THE DRAWINGS

The invention will be more readily understood with reference to the following drawings wherein like reference numbers represent like elements and wherein:

FIG. 1 is a block diagram illustrating one example of a data management system in accordance with one embodiment of the invention;

FIG. 2 is a flow chart illustrating one example of a method for creating and linking a first and second data descriptor item to a raw data item in accordance with one embodiment of the invention;

FIG. 3 is a block diagram illustrating one example of a data management system in accordance with one embodiment of the invention;

FIG. 4 is a block diagram illustrating one example of a data management system in accordance with one embodiment of the invention;

FIG. 5 is a block diagram illustrating one example of a data system in accordance with one embodiment of the invention that provides for the linking of data descriptor items to a raw data item in accordance with one embodiment of the invention;

FIG. 6 is a block diagram illustrating one example of a client-server data system in accordance with one embodiment of the invention in accordance with one embodiment of the invention;

FIG. 7 is a block diagram illustrating one example of a base knowledge container record in accordance with one embodiment of the invention;

FIG. 8 is a block diagram illustrating one example of a base knowledge container record in accordance with one embodiment of the invention;

FIG. 9 is a flow chart illustrating one example of a method as performed by a knowledge container creator module in accordance with one embodiment of the invention;

FIG. 10 is a flow chart illustrating one example of a method as performed by a knowledge container creator module in accordance with one embodiment of the invention;

FIG. 11 is a flow chart illustrating one example of a method as performed by a knowledge container searcher module in accordance with one embodiment of the invention;

FIG. 12 is a flow chart illustrating one example of a method as performed by a knowledge container searcher module in accordance with one embodiment of the invention;

FIG. 13 is a flow chart illustrating one example of a method as performed by a knowledge container searcher module in accordance with one embodiment of the invention;

FIG. 14 is a flow chart illustrating one example of a method as performed by a knowledge container administrator module in accordance with one embodiment of the invention;

FIG. 15 is a flow chart illustrating one example of a method as performed by the knowledge container administrator module in accordance with one embodiment of the invention;

FIG. 16 is a flow chart illustrating one example of a method for editing data descriptor items as associated with a knowledge container administrator module in accordance with one embodiment of the invention;

FIG. 17 represents one example of a screen shot of a window generated by the knowledge container creator module in accordance with one embodiment of the invention;

FIG. 18 represents one example of a screen shot of a window generated by the knowledge container searcher module in accordance with one embodiment of the invention;

FIG. 19 represents one example of a screen shot of a knowledge container viewer window containing base knowledge container information in accordance with one embodiment of the invention;

FIG. 20 represents one example of a screen shot of a window generated by the knowledge container administrative module in accordance with one embodiment of the invention;

FIG. 21 represents one example of a screen shot of a knowledge container viewer window containing system knowledge container information in accordance with one embodiment of the invention; and

FIG. 22 represents one example of a screen shot of a keyword editor window containing keyword information in accordance with one embodiment of the invention.

### DETAILED DESCRIPTION OF THE PREFERRED EMBODIMENT

Briefly, a data management system including a knowledge container creator module operative to create at least a first data descriptor item, such as a group of fields containing information such as product type and product configuration, and at least a second data descriptor item, such as a list of identified keywords, based upon a raw data item. The raw data item, such as a file containing tabular information collected as a result of the testing of a product or other physical system, is capable of containing test data representing raw data that is in one of a plurality of different formats, such as Microsoft Word™ documents, Microsoft Excel™ documents, video files and other items in otherwise unidentifiable formats, i.e., generic binary computer data. The knowledge container creator module also operative to link the raw data item to at the least a first data descriptor item and to link the raw data item to at least a second data descriptor item.

This provides for the advantage of associating raw data items, where raw data items can be files that contain information relating to the testing of new products, with first and second data descriptors, where such data descriptors contain information describing the information contained in the raw data items. This association provides a convenient means for locating test information based on a search of the associated test data description information. Further, when such associated information is stored in a commonly accessible database, an advantage is provided where diverse and remote users of such a system can locate and retrieve valuable test information created by others.

In one embodiment, the data management system includes a knowledge container administrator module operative to modify a template descriptor item, such as information defining the number and type of fields contained in a data descriptor as well as which of such fields will be searchable by the user, and operative to create knowledge transformation information, such as a decision tree that represents identified patterns in the data, e.g., thresholds for product attributes that can be used to classify “Pass/Fail” results in product testing by extrapolating data from a raw data item capable of containing test data representing raw data that is in one of a plurality of different formats. This provides one advantage of allowing for a centralized and dynamic way of maintaining data descriptor file layouts as well as the additional advantage of combining data mining tools capabilities within a multi-format file environment.

In one embodiment, the data management system includes a knowledge container creator module. The knowledge container creator module operative to link a raw data item, that is in one of a plurality of different formats, to at least a first data descriptor item. The first data descriptor item is in the form of a context descriptor, such as a group of one or more database fields, containing descriptive information about the raw data item. The knowledge container creator module is also operative to link the raw data item to at least a second data descriptor item. The second data descriptor item is in the form of at least one of: a decision-support data descriptor, containing data generated from the raw data item formatted per the requirements of a specific decision-support system, a keyword descriptor, identifying keywords contained in the raw data item, and a data access instructions descriptor, providing instructions on how to access the raw data in the raw data item. The data management system also includes a knowledge container searcher module. The knowledge container searcher module is operative to retrieve the raw data item by searching at least one of the first and second data descriptor items.

FIG. 1 illustrates a data management system 100 that includes a processing device 102, a knowledge container database 104 and a display 106. It will be recognized that other embodiments may use one or more displays, and one or more knowledge containers. As used herein “processing device” includes: one or more processing circuits executing software modules stored in memory, such as microprocessors, digital signal processors (DSPs), microcontrollers, a server(s), PC's laptops, workstations or alternatively discrete logic, state machines, or any suitable combination of hardware, software stored in memory and /or firmware. The display 106 is operatively connected via a suitable link 108 to the processing device 102 and displays a user interface to allow a user to interact with the data management system 100. Also as shown in this embodiment, the processing device 102 is also operatively coupled to the knowledge container database 104 via link 113.

The processing device 102 includes data management system software 116. As shown here, the data management system software 116 is in the form of one or more software modules executed on a microprocessor. A module represents a functional subset of software code within a software program. One of ordinary skill in the art will recognize that one or more modules may be included in a larger software program. Further, one of such skill will also recognize that any one or more modules may be merged into one large module. Further, any functionality from one module can be moved to another module. In this embodiment, knowledge container database 104 is further shown to contain the first data descriptor item 112, a second data descriptor item 114 and the raw data item 110. Although, the first data descriptor item 112 and the second data item descriptor 114 are shown contained in the same knowledge container database 104, one skilled in ordinary skill in the art will recognize that such items could be located in separate knowledge container databases 104, as well as in one or more devices. The raw data item 110 is also shown to exist in the same knowledge container database 104 as is the first data descriptor item 112 and the second data descriptor item 114. However, other embodiments locate the raw data item 110 in a separate database from either one or both of the first and second data descriptor items. In another embodiment, the raw data item 110 may have its entire contents located or stored within knowledge container database 104. In another embodiment the contents of raw data item 110 contents may be located or stored elsewhere where the raw data item simply includes a pointer, or other indicator, identifying where the contents of the raw data item 110 is stored.

The data management system software 116 includes a knowledge container creator module 118. The knowledge container creator module 118 is used to link data descriptor items, via links 112 and 114, to the raw data item 110. For example, via a user interface, knowledge container creator module 118 can store the data descriptor items, 110 and 112, and a pointer to the raw data item 110, in a common database record. In some embodiments, the knowledge container creator module 118 is also used to create data descriptor items 112 and 114.

The raw data item 110 can contain any one or more of a plurality of formats. Such formats need not be known to the data management system software 116 prior to its exposure to the data management system software 116. For example, such formats could include Microsoft Word™ documents, Microsoft Excel™ documents, video files, attribute relation file format (ARFF) formatted data or any other suitable type of formatted files. Other formats include, for example, strict binary files, strict text data, strict table data or other files not necessarily in a form that is readable by commercial off-the-shelf software. Yet other formats include a link to particular data rather than the data itself. The data management system software 116 is capable of processing any such formats of raw data items 110 where such formats need not currently exist at the time the data management system software 116 is designed, created, compiled or otherwise embodied in an operational system. In one embodiment, the data management system software 116 processes the contents of the raw data item 110 looking for American Standard Code for Information Interchange (ASCII) character sets that represent words, and when found, further processes such words as potential keyword descriptors 408. In one embodiment, when the file type is known by the keyword generation routine, specialized methods can be used to parse the input file and identify candidates for keywords. For example, the parser knows to skip the formatting information in a Microsoft Word™ document, and look for candidate keywords in the text portion of the document. Within a generic binary document, it is possible to identify text strings by identifying sets of contiguous bytes that correspond to ASCII characters that are letters of the alphabet. In one embodiment, this method includes the identification of candidate keywords from both generic binary data and from special-format files.

As such, the data management system software 116 can process raw data items 110 that were generated in formats unknown to such system when last compiled, designed or otherwise implemented. Therefore, one advantage of the data management system software 116 is its broad ability to associate raw data items 110 of a variety and otherwise unknown formats to one or more data descriptor items 112 and 114 and such associations can be done without the need for any recompiling of the data management system software 116, or any components thereof, or the need to otherwise have to change or otherwise reconfigure the data management system software 116.

The first data descriptor item 112 and the second data descriptor item 114 are contained within knowledge container database 104. Data descriptor items, 112 and 114, contain metaknowledge information where the term “metaknowledge” is used to mean information about the raw data item 110. Such metaknowledge information can be either generated manually or generated automatically. For example, manually generated items can be entered by a user via I/O (input/output) techniques, while other items may be generated by a program that processes the raw data item 110.

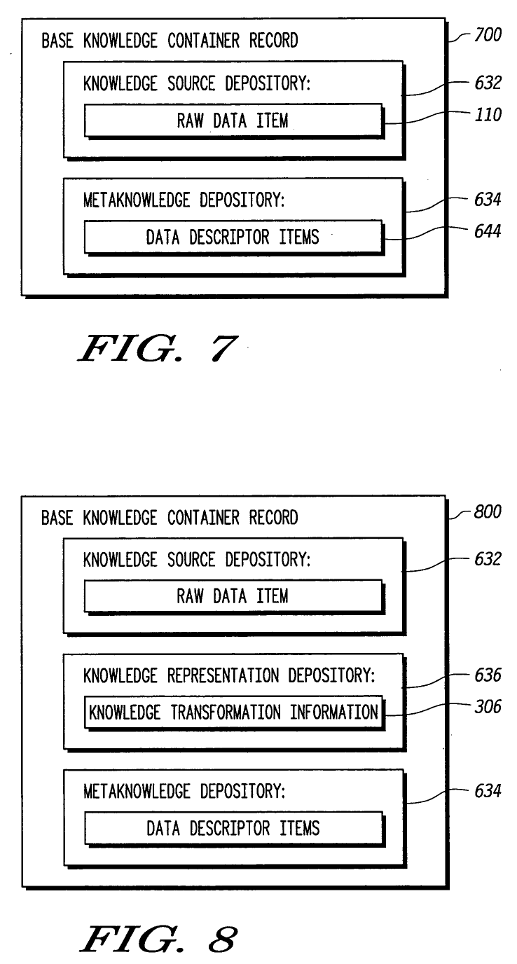

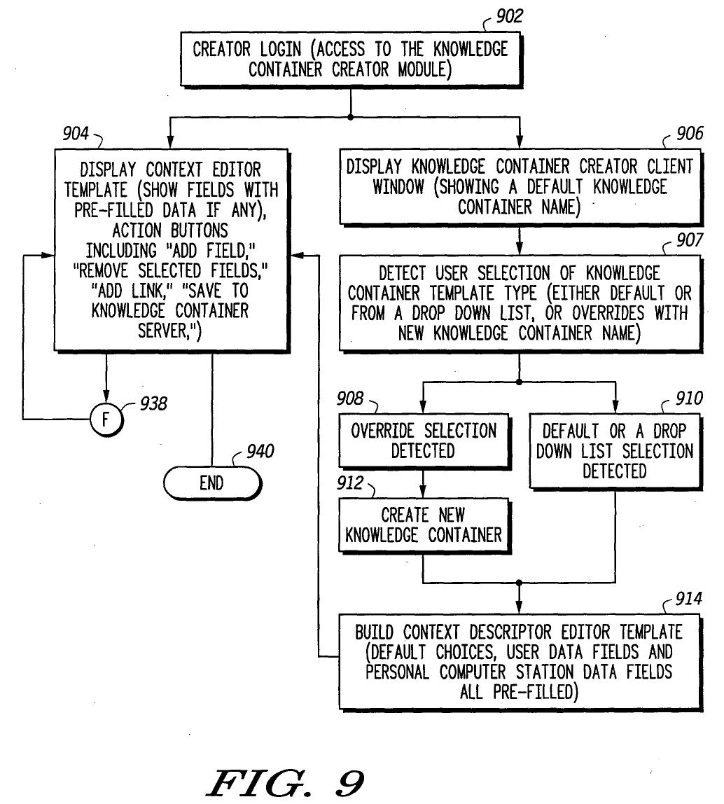

In sum, such data descriptor items, 112 and 114, include descriptive information that can later be searched to locate raw data items 110. Such data descriptor items can also contain instructions as to how to access, use or otherwise interpret the information stored in a corresponding raw data item 110. The first and second data descriptor items 112 and 114 are shown linked to raw data item 110 via links 120 and 122. Such links, 120 and 122, are provided through any suitable database structure. In one embodiment, as described below in regard to FIGS. 7 and 8, the links represent a database record formatted in XML that includes both the data descriptor items, 112 and 114, and a pointer or link information containing the location of the raw data item 110.

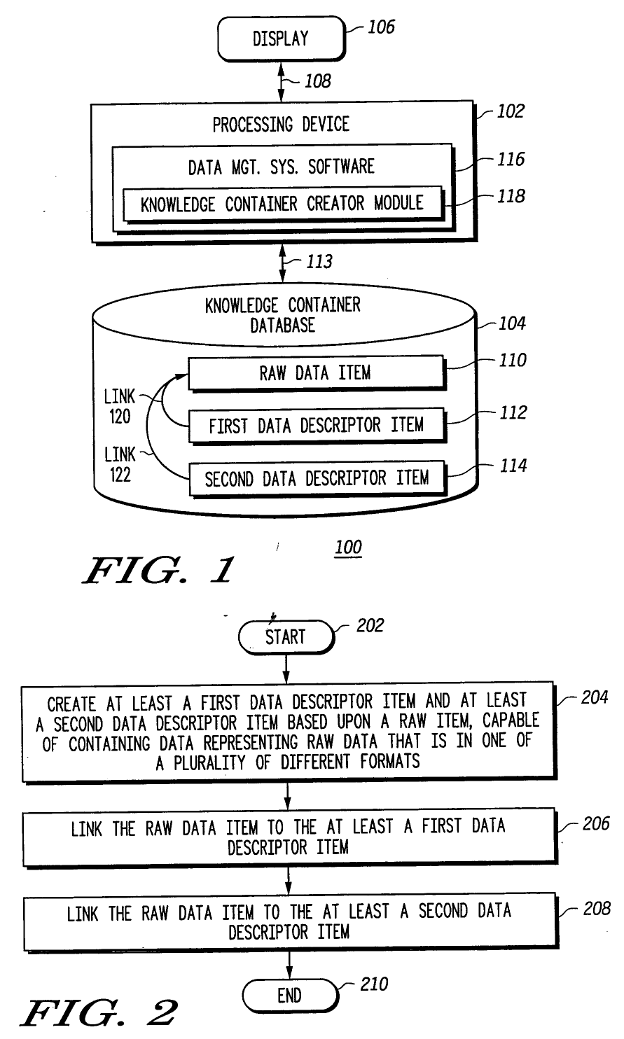

FIG. 2 shows a method of using a the data management system 100 to create at least a first data descriptor item 112 and at least a second data descriptor item 114 based upon a raw data item 110 that is in one of a plurality of different formats. For example, a raw data item 110 could be in the form of a Microsoft Word™ file and could describe a test that was recently performed. Here, the data management system 100, via knowledge container creator module 118, generates graphical user interface (GUI) in the form of a knowledge container creator window. A representative screen shot of such window is shown in FIG. 17.

Through the GUI, the knowledge container creator module 118 receives inputs from a user identifying the knowledge container file to store the about to be created base knowledge container record which will contain the first data descriptor 112, the second data descriptor 114, and a pointer to the raw data item 110. Upon receiving the input, the knowledge container creator module 118 reads a corresponding template descriptor item from the file containing the server system knowledge containers. The knowledge container creator module 118 then retrieves from the server system knowledge container record information therein indicating such things as the layout of the corresponding base system knowledge container records, such as what fields of information are stored therein for describing the test information in the raw data item 110, as well as identifying input restrictions on such fields including whether such fields are limited to a finite number of inputs that can be chosen from a drop down list. In addition, the system knowledge container record information can also include a list of wanted and unwanted keywords that are used to search the raw data item 110.

The knowledge container creator module 118 then uses the server system knowledge container record information to generate a second GUI, in the form of a context window editor. Here, input fields are displayed to the user that correspond to a context descriptor. Such input fields can include such things as product configuration and product name.

Through another GUI, a link editor window displayed on the display 102 with the other two GUIs, and via the knowledge container creator module 118 receives a user inputted file name and location identifying the file containing the raw data item 110. Once the filename and location is received the knowledge container creator module 118 reads the file in preparation for processing its contents.

When a file command request is detected from the knowledge container creator window the container creator module 118 performs the following tasks: (1) process the raw data item 110 by parsing the file searching for ASCII characters identified as words (using the wanted and unwanted keyword list from the template descriptor item), and storing such keywords in a list as the second data descriptor item; (2) if the raw data item 110 is located on a device other than the device where the knowledge container database 104 is located, then the contents of the raw data item 110 is copied into the knowledge container database 104; (3) format the first data descriptor item 112, the second data descriptor item 114, and the pointer to the location of the raw data item, in XML format, (See discussion regarding FIGS. 7 and 8), for storing as a base knowledge container record in the knowledge container database 103; (4) link the raw data item 110 to the first and second data descriptor items 112 and 114, by writing the XML formatted information of the first data descriptor 112, the second data descriptor 114, and the pointers to the location of the raw data item 110, in the form of a base knowledge container record to the to the knowledge container database 104; and (5) update the associated template descriptor item by adding the list of identified keywords thereto.

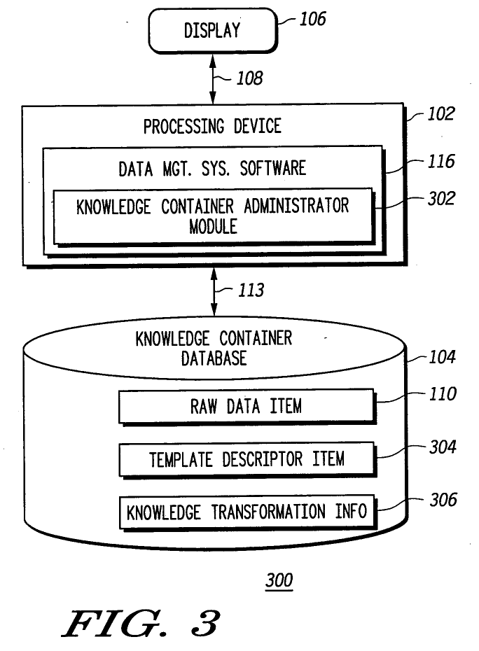

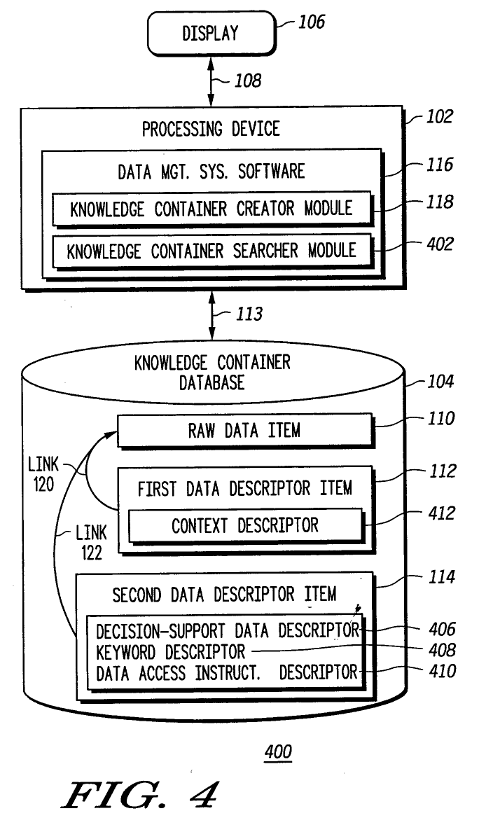

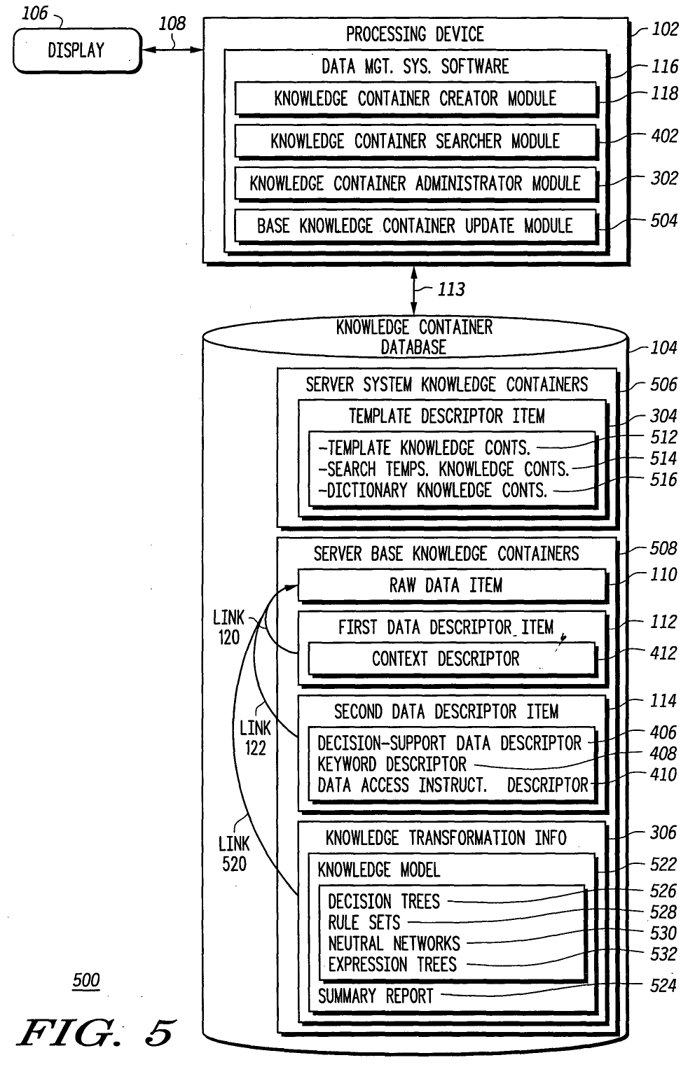

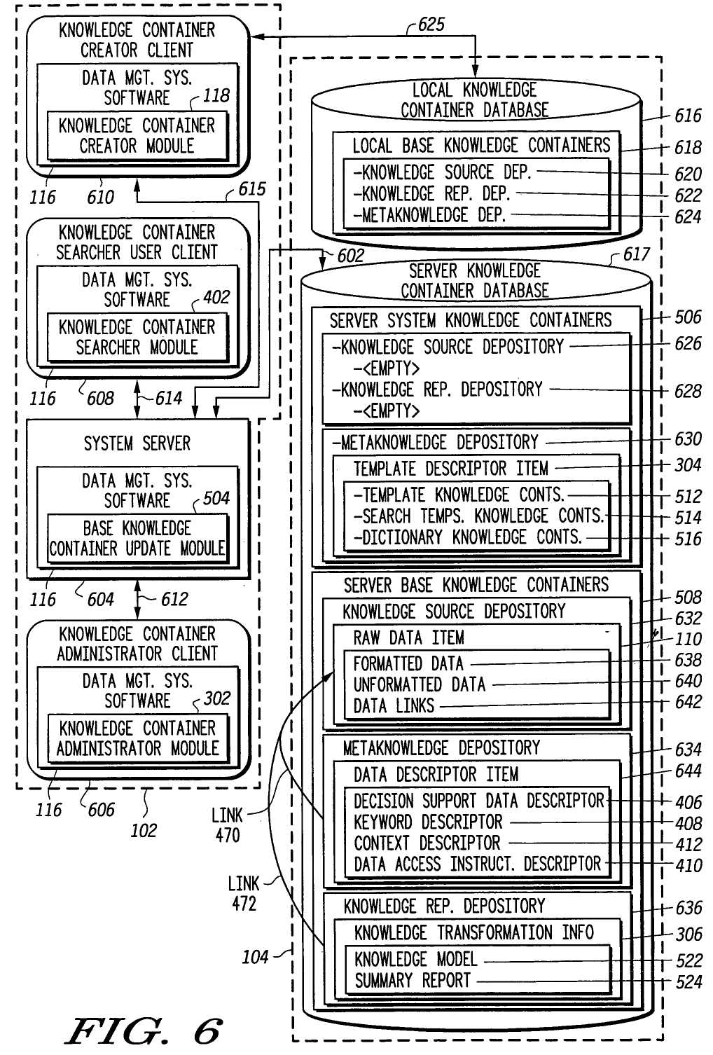

FIG. 3 illustrates an example of a data management system 300 that also includes a processing device 102, a knowledge container database 104 and a display 106. In this embodiment, the data management system 300 includes a knowledge container administrator module 302. Also in this embodiment, the knowledge container database 104 is further shown to contain a template descriptor item 304, the raw data item 110 and knowledge transformation information 306. Here, the template descriptor item 304 contains information regarding the format and presentation of the information stored in the knowledge container database 104 as well as related searching functionality. The template descriptor item 304 is discussed in greater detail with regard to FIG. 5 below.

The knowledge transformation information 306 is developed by processing the data in raw data item 110, and either summarizing the data therein or identifying patterns therein that provide more information about such data than just the data itself. An example of the generation of summary data would be the identification of detailed statistical information, such as the average, mean and mode of the force needed to cause breakage of the housing of a mobile phone. An example of identifying patterns, includes the identifying, within the raw data item 110, information that when a certain temperature is reached for a certain duration, that nearby components will fail at a predictable rate. For example, the locations of the components are known, the temperatures are known and when a particular component failed is also known, and therefrom such pattern information is identified. These patterns, which can be discovered using one or more techniques, such as regression analysis, classification based on association (CBA), and gene expression programming (GEP), can be used to guide future design choices. The various types of knowledge transformation information are discussed in more detail below with regard to FIG. 5.

The knowledge container administrator module 302 is used to modify the template descriptor item 304. Generally, the template descriptor item 304 is used to control the input for entering the context descriptors 412. For example, the administrator module 302 allows an administrator user to add or remove fields associated with a template descriptor item 304, such as descriptive test data information including product name and product configuration, e.g., “X650,” and “Phone Body,” respectively. The use of an easy modifiable template descriptor item 304 provides an easy method for controlling the format of and the corresponding GUI information associated with the first and second data descriptor items 112 and 114.

FIG. 4 illustrates a data management system 400 that is similar to that shown in FIG. 1, but further includes a knowledge container searcher module 402. Here, the knowledge container searcher module 402 is used to search the data descriptor items 112 and 114 to locate associated raw data items 110. To the extent that the knowledge container creator module 118 and the knowledge container searcher module 402 are shown on the same processing device 102, one of ordinary skill in the art, will recognize that such circuitry could be located on separate processing devices, while coupled to the same knowledge container database 104. As shown here, the data descriptor items, 112 and 114, can be of several types including; decision-support data descriptor 406, a keyword descriptor 408, a data access instructions descriptor 410 and a context descriptor 412.

The decision-support data descriptors 406 may include decision-support information as generated and recognized by any one of a wide variety of available decision-support tools that read and/or write to the knowledge container. The decision-support information is generated in a format that meets the requirements of the associated target decision-support applications. This includes, but is not limited to, decision-support information as generated and recognized by many artificial intelligence and machine learning applications (AI Applications). Here, the contents of the decision-support data descriptors 406 are generated by an AI Application that is processed from the contents of the raw data item 110. An example of such an AI Application and the output thereof is C4.5 System for Rule Induction developed by Ross Quinlann (Ref. httv://m croft.ncsa.uiuc.edu/www-0/projects/HPML/c4.5rules.html) and its corresponding output of decision trees and rules. Another example is the D2K System developed by the National Center for Supercomputing Applications (NCSA) (Ref. http://www.ncsa.uiuc.edu/TechFocus/Projects/NCSA/D2K_-_Data_To_Knowledge.html).

The keyword descriptor 408 contains keywords that have been identified as being present in the raw data item 110. Such keywords are generated when the raw data item 110 is initially linked to a corresponding template descriptor item 304. In this example, such keywords are generated by a straight ASCII character search of the raw data item 110 where the data management system 100 need not have any information about the format of the raw data item 110 to perform the search for keywords. However, other keyword searching capabilities may be specifically directed to specific types of known formatted raw data items 110. For example, .xls files may be searched in such a manner as to take advantage of the pre-existing knowledge of the format of the Microsoft Excel™ spreadsheet formats. Such keywords can include such exemplary words as “earpiece,” “speed” and “length.”

The data access instruction descriptors 410 contain information describing the raw data 110, including instructions that are either user readable or computer readable. The user readable text can be, for example, a textual description instructing how to access or otherwise manipulate or use the information stored in the raw data item 110, e.g., “Raw data for drop test video P2K-1234.avi are stored in the Lab Data Directory under the same name.” The computer readable instructions can include direct transfer code or processing transfer code where processing transfer codes can include any of the following: data processing, filtering, and fast Fourier transforms. The direct transfer code establishes a mapping of elements of the raw data item 110 to elements in the data access instruction descriptors 410. The transfer processing code established the manner in which the raw data items 110 are transformed, e.g., by filtering, in order to obtain the elements in the data access instruction descriptors 410. Whereas the former code defines essentially a one-to-one mapping between the raw data items 110 and data access instruction descriptors 410, the latter code may include complex numerical processing and result in fewer or more elements in data access instruction descriptors 410 than in the raw data items 110.

The context descriptor 412 contains information such as who, what, where, why and how-type information related to the data item 110. For example, such information can include who entered the test data, at what location, what the subject of the test was, what the purpose of the test was and how the test was performed. Here, such who, what, where, why and how-type information is stored in fields in a base knowledge container record. Further, such field information may be displayed to a user via a GUI on a display 106 and the user can modify the same field information through the same GUI. More specifically, a user may manually enter a part name, a part size, and the type of experiments performed while the data management system 100 may automatically populate additional fields such as the time of data creation, location of the creation and the user who created it. In this example, the context descriptor 412 is in the form of data fields where data fields are populated by both the computer and by a data management system user. Context descriptor 412 related information can include such information as the name of the person creating the knowledge container entry, their department, the product number and the product configuration. For example, the specific information for such fields respectively could be “Bob Jones,” “B500,” “X650” and “Phone Body.”

Shown in FIG. 5 is an example of a data management system 500 having the display 106, the processing device 102 and the knowledge container database 104. The display 106 is connected to the processing device 102 via connection 108. The knowledge container database 104 is also connected to the processing device 102 via connection 113. Here, the processing device 102 is similar to the processing device 102 of FIG. 4 wherein processing device 102 here contains the additional modules of: knowledge container administrator module 302 and base knowledge container update module 504.

Also, the knowledge container database 104 is similar to knowledge container database 104, except that here knowledge container database 104 contains both server system knowledge containers 506 and server base containers 508. Server base knowledge containers 508 contain information generally related to the raw data item 110 information. That is discussed in greater detail below with regard to FIG. 6. In contrast, the server system knowledge containers 506 contain information regarding the format and presentation of the information stored in the server base knowledge containers 434 as well as related searching functionality. The server system knowledge containers 382 include a template descriptor item 304 where the template descriptor item 304 includes template knowledge containers 512, search template knowledge containers 514 and dictionary knowledge containers 516.

As discussed above regarding FIG. 3, the template descriptor item 304 is used to control the format and GUI associated with the context descriptors 412. The search template knowledge containers 514 are used to control which fields are used, i.e., which context descriptors 412, to search the data descriptor items. This provides an easy method for controlling what information that users, via the knowledge container searcher module 402, can enter to search the data descriptor-type information. The dictionary knowledge containers 516 are used to generate keyword descriptors 408. This provides a method for controlling which keywords are to be captured and which are not. Not only are the template descriptor items 304 easily changeable, i.e., adding or deleting, such changes can occur with little or no impact on the users where such modifications can be performed while users are otherwise using the overall system.

Representing the knowledge container templates 512, knowledge container search templates 514, and knowledge container dictionaries 516, as knowledge containers has the significant advantages of easy manipulation with standardized software modules and easy sharing between different computer modules. The use of knowledge container search templates 514 makes it possible for the system, via a system administrator, to passively guide a user's searches by enabling specific sets of categories, in addition to the genericpkeyword search. This facilitates searches of the database according to naturally evolving groupings of knowledge, as determined by the system administrator, who manages the knowledge container and knowledge container search templates 514. In one embodiment the software updates the template descriptor items 304 at the server 604, and corresponding clients (606, 608 and 610) are automatically updated. This has the advantage of allowing new or modified template descriptor items 304 to be distributed to all devices of the system, without the software on each device needing to be upgraded.

In more detail, the template knowledge containers 512 are used to store information that describes the layout of the context editor window and other data descriptor items. For example, the context editor window of FIG. 17, has a corresponding knowledge container template 512 identifying a context descriptor 412 having five fields of: “configuration,” “user,” “department,” “location” and “product.” Such knowledge container template 512 also identifies formatting options related to the five fields. For example, the field “product” may be limited to only alphanumeric information, or may be further limited by a list of known products that is displayed on the context editor window as a drop down box. In this example, the knowledge container administrator module 302 provides, via a GUI interface, for the updating of the template descriptor items 304 used to control the creating and searching of the data descriptor items 112 and 114.

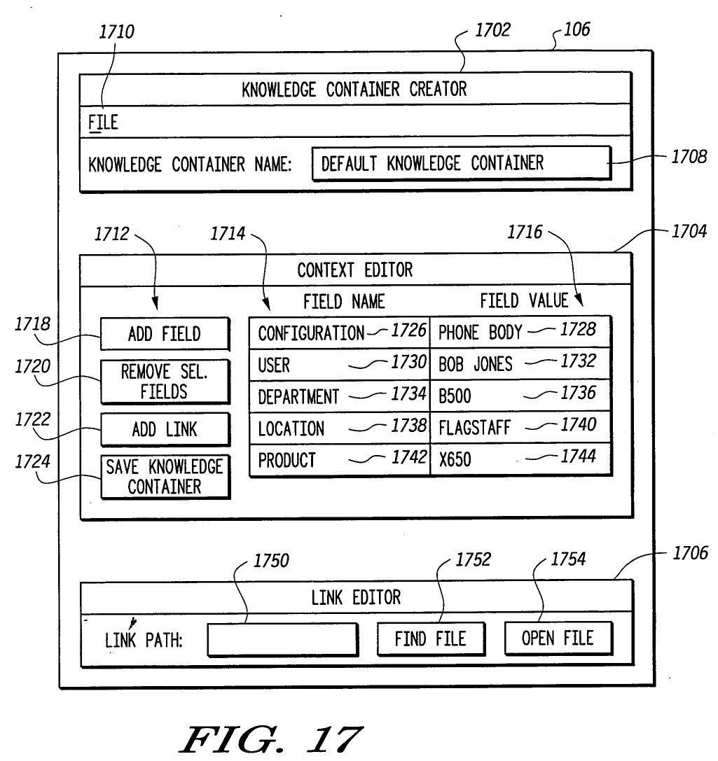

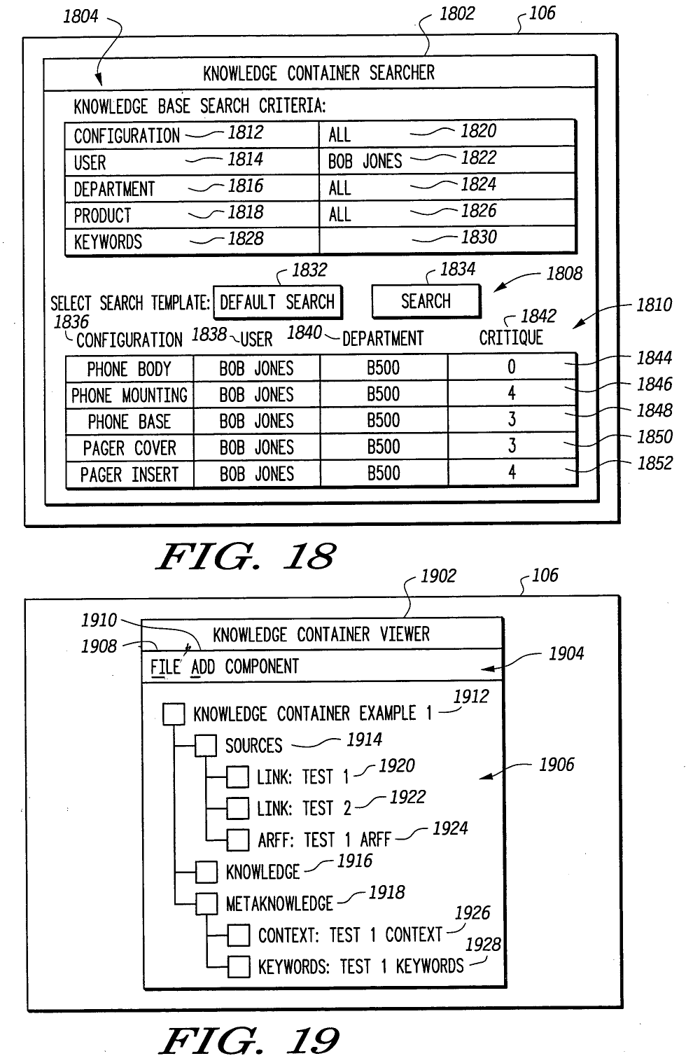

Knowledge container search template 514 is used to control what inputs are ultimately displayed to a searcher user for searching the knowledge container database 104. For example, the knowledge container searcher window of FIG. 18, has a corresponding knowledge container search template 514 identifying searchable fields of the context descriptor 412, for example, the four fields of: “configuration,” “user,” “department” and “product.” In addition, the knowledge container search template 514 also contains keyword descriptor searchable fields such that the knowledge container searcher module 402 generates an input field in the searcher window with an input for keywords. The knowledge container template 514 also identifies formatting options. For example, the field “product” may be limited by a list of known products that is displayed on the context editor window as a drop-down box. Similarly, the knowledge container administrator module 302, via administrator user interaction through the knowledge container viewer window, and ultimately, for example, through the context editor window, can update such knowledge container search template 514 information to control what information, i.e., what context descriptors 412 may be inputted, or searched on, via the knowledge container searcher module 402 and the corresponding knowledge container searcher window.

The knowledge container dictionary 516 is used to control what keywords are selected for a given knowledge container, from among the candidate keywords in a raw data item 110 that has been linked to the knowledge container. In one embodiment a dictionary of “wanted words” and a dictionary of “unwanted words” are used to filter the list of candidate keywords, and identify those that will result in the highest quality search results for a specific knowledge area. Thus, the knowledge container dictionaries 516 and the keywords ultimately affect what is displayed to a searcher user for searching the knowledge container database 104. The knowledge container administrator module 302, via user interaction through the knowledge container administrator window, and ultimately, for example, trough the keyword editor window can update such knowledge container search template 512 information to control what information, i.e., what keywords may be inputted, or searched on, via the knowledge container searcher module 402 and the corresponding knowledge container searcher window.

Dictionary knowledge containers 516 are used by the knowledge container searcher module 402 to control what keyword inputs are ultimately displayed to a searcher user for searching the knowledge container database 104. The knowledge container administrator module 302, via user interaction through the knowledge container administrator window and ultimately, for example, through the keyword editor window, can update such knowledge container search template 512 to control what information, i.e., what keywords may be inputted, or searched on, via the knowledge container searcher module 402 and the corresponding knowledge container searcher window. The knowledge container administrator module 302, in this example, is also used to create knowledge transformation information 306, as well as to link the raw data item 110 to such knowledge transformation information 306 via link 520. Knowledge container database 104 is similar to knowledge container database 104 of FIG. 4 wherein here, the knowledge container database 104 further includes the knowledge transformation information 306 that contains a knowledge model 522 and a summary report 524. As discussed above with regard to FIG. 3, the knowledge transformation information 306 is developed by processing data in the raw data item 110 and identify patterns therein that provide more information about such data that simply the data itself. Knowledge models 522 can include decision trees 526, rule sets 528, neural networks 530 and expression trees 532.

Knowledge models 522 can be generated by analyzing the information in the raw data item 110, identifying patterns, and generating algorithms based on these patterns. In the most generic case, a knowledge model 522 is a simple input-output model that represents a cause-and-effect relationship, which the raw data appear to obey. Examples of models may include equations, decision trees, and rule sets. For example, a pattern may be identified in the raw data item 110 information that when a certain temperature is reached for a certain duration, that nearby components will fail at a predictable rate. Once knowledge models 522 are identified, they can be stored in the form of decision trees 526, rule sets 528, neural networks 530 and expression trees 532. The use of such knowledge models 522 in representing such types of knowledge transformation information 306 is well known to those skilled in the art. Decision trees 526 can take the form of the text that is outputted from C4.5 Decision Tree™ software. Rule sets 528 can be represented in one of the commonly used expert system formats, such as the C-Language Integrated Programming System (CLIPS). Neural networks 530 are known to be in the form of the node configurations and weights associated with multi-layer back-propagation systems. Expression trees 532 can be represented in Microsoft Excel™ equation format or in a text format as outputted by other software that is used in gene expression programming.

FIG. 6 shows the processing device 102 and the database 104 connected via connection 602. Here the processing device 102 is further made up of both a server 604 and clients 606, 608 and 610. The server 604 is connected to the knowledge container administrator client 606, knowledge container searcher user client 608, and knowledge container creator client 610 via connections 612, 614 and 615 respectively. In this example the processing device is represented by multiple devices. Although this embodiment shows processing device 102 as consisting of both system server 604 and corresponding client devices 606, 608 and 610, other embodiments use more or less clients and more or less system servers. The data management system software 116 exists at each client and each server. Knowledge container administrator client 606 has data management system software 116 that further includes a knowledge container administrative module 302. The knowledge container searcher user client 608 contains data management system software 116 and further includes a knowledge container searcher module 402. The knowledge container creator client 610 further contains the data management system software 116 which further includes a knowledge container creator module 118. Finally, system server 604 is contains the data management system software 116 and further include the base knowledge container update module 504. The base knowledge container update module 504 takes the input from the creator client 610, and constructs a new knowledge container in the specified XML format, which is subsequently stored in the server knowledge container database 617. If modifications for an existing knowledge container are coming from the administrator client 606, then after the updated knowledge container is created in the XML format, the system overwrites the existing knowledge container in the server knowledge container database 617.

Knowledge container database 104 includes both a local knowledge container database 616 and a server knowledge container database 617. As shown here, local knowledge container database 616 includes local base knowledge containers 618 which, in turn, further include three depositories: the knowledge source depository 620, the knowledge representation depository 622 and the metaknowledge depository 624.

Like the server knowledge container database 104 as shown in FIG. 5, the server knowledge container database 617 here includes both server system knowledge containers 506 and server base knowledge containers 508. Server system knowledge containers 506 are further shown to contain a knowledge source depository 626, a knowledge representation depository 628 and a metaknowledge depository 630. Although it is part of the standard knowledge container template, here, the knowledge source depository 626 is not used. The source is assumed to be the system administrator. Likewise, the knowledge representation depository 628 is empty. System knowledge containers, i.e., knowledge container templates 512, knowledge container search templates 514, and knowledge container dictionaries 516 are used for their metaknowledge only. However, the metaknowledge depository 630 includes the template descriptor item 304. The use of such the template descriptor item 304 information is discussed above regarding FIG. 5, and in conjunction with the knowledge container administrative module 302.

Below is a representation of knowledge container template 512 which is used by the system, as templates, to “create” knowledge containers. The example is for Ultra High Speed Video.

```
<AI>
  - <KnowledgeContainer id=“create: Ultra High Speed Video”>
      <Source />
      <Knowledge />
    - <MetaKnowledge>
      - <Context id=“UHSV Template”>
        <Type>Ultra High Speed Video Template</Type>
        <People />
        <TestTeam friendlyname=“Customer for Test” />
        <Department />
        <Access>Anyone, Creator Only, Department Only</Access>
        <Location>LMTC Lab</Location>
        <Part>Antenna, Connector, Display, Housing, Keypad, Lense,
          Other</Part>
        <DevelopmentName friendlyname=“Development
          Name”>Phoenix, Talon, Tarpon, TA02,
          Other</DevelopmentName>
        <RevisionNo friendlyname=“Revision Number” />
        <ImpactOrientation friendlyname=“Impact Orientation”>Top,
          Bottom, Front, Front Open, Back, Back Open, Left,
          Right</ImpactOrientation>
        <DropResult friendlyname=“Drop Test Result”>Pass, Display
          Crack, Housing Crack, Internal Failure</DropResult>
        <Abstract friendlyname=“Abstract” />
        <DefaultFileLocation friendlyname=“Default File
          Location”>d:\download\</DefaultFileLocation>
      </Context>
    </MetaKnowledge>
  </KnowledgeContainer>
</AI>
```

Here, “<AI>” represents the beginning of the information to be read or written by the target program, e.g., a generic artificial intelligence (AI) system. “<KnowledgeContainer id=″create: Ultra High Speed Video″” represents the beginning of the knowledge container and where the “id” is an attribute that specifies the name of the knowledge container. The word “create:” means that this is a system server knowledge container 506, which will be used as a knowledge container template 512 for creating knowledge containers. “<Source />” represents a placeholder for the knowledge source depository 626 defined in the knowledge container architecture. Because this is a system server knowledge container 506, the knowledge source depository 626 is assumed to be the system itself, and therefore no knowledge source depository 626 appears in this knowledge container. “<Knowledge />,” as used here is a placeholder for the knowledge representation depository 628 defined in the knowledge container architecture. It should be noted that because this is a system server knowledge container 506, there is no knowledge representation depository 628.

“<MetaKnowledge>” is the beginning of the metaknowledge depository 630 defined in the knowledge container architecture. “<Context id=″UHSV Template″>” represents the beginning of the knowledge container template 512 which is a subsection of the metaknowledge depository 630 in the knowledge container architecture. “<Type>Ultra High Speed Video Template</Type>” identifies the type of the knowledge container. “<People />” is a placeholder for the section where the people who “own” this knowledge are listed. It should be noted that since this is a knowledge container template 512, and not an actual populated knowledge container, there are no people listed. “TestTeam friendlyname=″Customer for Test″ />” is a placeholder for the section where the people who will use this knowledge are listed. The attribute “friendlyname” specifies the title for this data record. It should be noted that since this is a knowledge container template 512, and not an actual populated knowledge container, there are no customers listed. “<Department />” is a placeholder for the section where the department name (of the organization unit that created the knowledge container) is listed. Since this is a knowledge container template 512, and not an actual populated knowledge container, there is no department listed.

“<Access>Anyone, Creator Only, Department Only</Access>” is a list of possible levels for read-access permission. When the knowledge container creator user supplies the actual knowledge, he/she will be prompted to select one of these three possible levels from the template. “<Location>LMTC Lab</Location>” is the default name of the location at which the knowledge container is created. “<Part>Antenna, Connector, Display, Housing, Keypad, Lense, Other</Part>” is the list of possible entries for the “Part” record in the knowledge container. In this example, they describe the main parts of a mobile phone. “<DevelopmentName friendlyname=″Development Name″>Phoenix, Talon, TA02, Other</DevelopmentName>” is a list of possible entries for the ″DevelopmentName″ record in the knowledge container. In this example, they include development names for products, plus the “Other” category. The “friendlyname” attribute is used to tell the system to display this as “Development Name.” “<RevisionNo friendlyname=″Revision Number″ />” is a placeholder for the section where the product revision number is recorded. The attribute “friendlyname” specifies the title for this data record.

“<ImpactOrientation friendlyname=″Impact Orientation″>Top, Bottom, Front, Front Open, Back, Back Open, Left, Right</ImpactOrientation>” is a list of possible entries for the “Impact Orientation” record in the knowledge container. In this example, they include eight possible product orientations in which a drop test could be conducted. The “friendlyname” attribute is used to tell the system to display this as “Impact Orientation.” “<DropResult friendlyname=″Drop Test Result″>Pass, Display Crack, Housing Crack, Internal Failure</DropResult>” is a list of possible entries for the “Drop Result” record in the knowledge container. In this example, they include four possible outcomes from a drop test of a mobile phone. The “friendlyname” attribute is used to tell the system to display this as “Drop Test Result.” “<Abstract friendlyname=″Abstract″ /” is a placeholder for the section where the text description of the knowledge container, as input by the knowledge container creator user, is recorded. The attribute “friendlyname” specifies the title for this data record. <DefaultFileLocation friendlyname=″Default File Location″>d:\download\</DefaultFileLocation> is the default path (as on a computer file system) for the files, if any, that are linked to this knowledge container. In practice, the default path is configured according to the data management procedures on the computer to which the measurement equipment is connected. The attribute “friendlyname” specifies the title for this data record. “</Context>” is the end of the knowledge container template 512. </MetaKnowledge> is the beginning of the metaknowledge section. “</KnowledgeContainer>” is the end of the knowledge container. “</AI>” identifies the end of the information to be read or written by the system.

Server base knowledge containers 508 include three depositories that are similar to those associated with the local knowledge container database 616, and like the server system knowledge container 506, contain a knowledge source depository 632, a metaknowledge depository 634, and a knowledge representation depository 636.

The knowledge source depository 632 contains the raw data items 110. The raw data items 110 can be any one of the three different types: formatted data 638, unformatted data 640 or data links 642. Formatted data 638 can be any number of currently existing or future existing formats that arrange binary encoded data for use with computer applications. As discussed above regarding FIG. 4, such formatted data includes, for example: Microsoft Word™ documents, Microsoft Excel™ documents, video files and files in the ARFF format. Unformatted data 640 includes, for example, files containing strict binary data, strict text data and strict table data. Data links 642, rather than including the data itself, instead contains links to such information where the links can be to any accessible location or device include remote data bases and remote web servers.

The knowledge representation depository 636 contains the knowledge transformation information 306 as discussed above regarding FIG. 3. The metaknowledge depository 634 contains the context descriptors 412, decision-support data descriptors 406, keyword descriptors 408 and data access instruction descriptors 410 as discussed above regarding FIG. 4.

FIG. 7 shows a base knowledge container record 700. In this embodiment the base knowledge container record 700 is stored in the knowledge container database 104. The base knowledge container record 700 is shown in the below example as beginning and ending with the following: <KnowledgeContainer id=“X”> . . . </KnowledgeContainer>. The knowledge container record stores the raw data item 110 in the knowledge source depository 632, and stores the data descriptor items 644 in the metaknowledge depository 634. Each depository (including the knowledge representation depository 636 of FIG. 8) represents a different section within the base knowledge container record 700 as shown in the below example, each beginning and ending with the following: </Source> . . . </Source>, </Knowledge> . . . </Knowledge> and </MetaKnowledge> . . . </MetaKnowledge>. Within each section file that contains one or more data blocks used to represent the contents therein. Here, the data blocks are formatted using the Extensible Markup Language (XML). An example of the internal XML format of a knowledge container 700 is as follows:

```
<KnowledgeContainer id=“X”>
  <Source>
  ...
  </Source>
  <Knowledge>
  ...
  </Knowledge>
  <MetaKnowedge>
  ...
  </MetaKnowledge>
</KnowledgeContainer>
```

Shown in the below example is an XML representation the knowledge source depository 632, i.e., that delineated within the <Source> . . . </Source>section. Within the knowledge source depository section are separate subsections representing the formatted data 638, the unformatted data 640 and the data links 642. More specifically the formatted data is represented here as <ARFF> . . . </ARFF>, here the formatted data being ARFF-type, the unformatted data 640 is represented as <Unformatted> . . . </Unformatted> and the data link 642 is represented as <Link> . . . </Link>. The example of the internal XML format of a knowledge source depository 632 is as follows:

```
<Source>
  <ARFF>
  ...
  </ARFF>
  <Unformatted>
  ...
  </Unformatted>
  <Link>
  ...
  </Link>
</Source>
```

The detailed XML representation for the actual datablocks containing the details within each subsection, e.g., the formatted data 638, the unformatted data 640 and the data links 642, are not provided here. Such information regarding the storing of such like information in XML is well known to those of ordinary skill in the art. An example of such is the Data Mining Group Predictive Model Markup Language™ (PMML). However, in the current embodiment, in an effort to reduce the wordiness and associated high storage and computational demand associated with parsing the XML in the PMML format, data block definitions are used in the form of a table or matrix, rather than the PMML format which uses an element-by-element definition. Within the PMML format, the tag “Con,” as shown below, represents a connection to a specific node in the neural network, from another node specified by the “from” attribute. Each connection in the neural network has an associated “weight” attribute, which corresponds to the strength of the interconnection between two nodes. For example, where PMML would represent the a neuron of a neural network as follows:

```
<NeuralLayer>
  <Neuron id=”10”>
    <Con from=”0” weight=”−2.08148”/>
    <Con from=”1” weight=”3.69657”/>
    <Con from=”2” weight=”−1.89986”/>
    <Con from=”3” weight=”5.61779”/>
    <Con from=”4” weight=”0.427558”/>
    <Con from=”5” weight=”−1.25971”/>
    <Con from=”6” weight=”−6.55549”/>
    <Con from=”7” weight=”−4.62773”/>
    <Con from=”8” weight=”−1.97525”/>
    <Con from=”9” weight=”−1.0962”/>
    </Neuron>
      ...
</NeuralLayer>
```

The current embodiment would instead represent the same information as follows:

```
<NeuralLayer>
  <Column>
    from
    weight
  </Column>
    <Neuron id=”10”>
      0 −2.08148
      1 3.69657
      2 −1.89986
      3 5.61779
      4 0.427558
      5 −1.25971
      6 −6.55549
      7 −4.62773
      8 1.97525
      9 −1.0962
    </Neuron>
  ...
</NeuralLayer>
```

Included in the knowledge source depository 632 is a raw data item 110. The metaknowledge depository 634 contains data descriptor items 644. In this embodiment, base knowledge container records 700 are the units that make up the knowledge container database 104.

FIG. 8 shows one embodiment containing a base knowledge container 800 further containing a knowledge source depository 632, a knowledge representation depository 636 and a metaknowledge depository 634. Unlike the base knowledge container record 700 shown in FIG. 7, the base knowledge container 800 further includes the additional knowledge representation depository 636 which in turn further includes the knowledge transformation information 306.

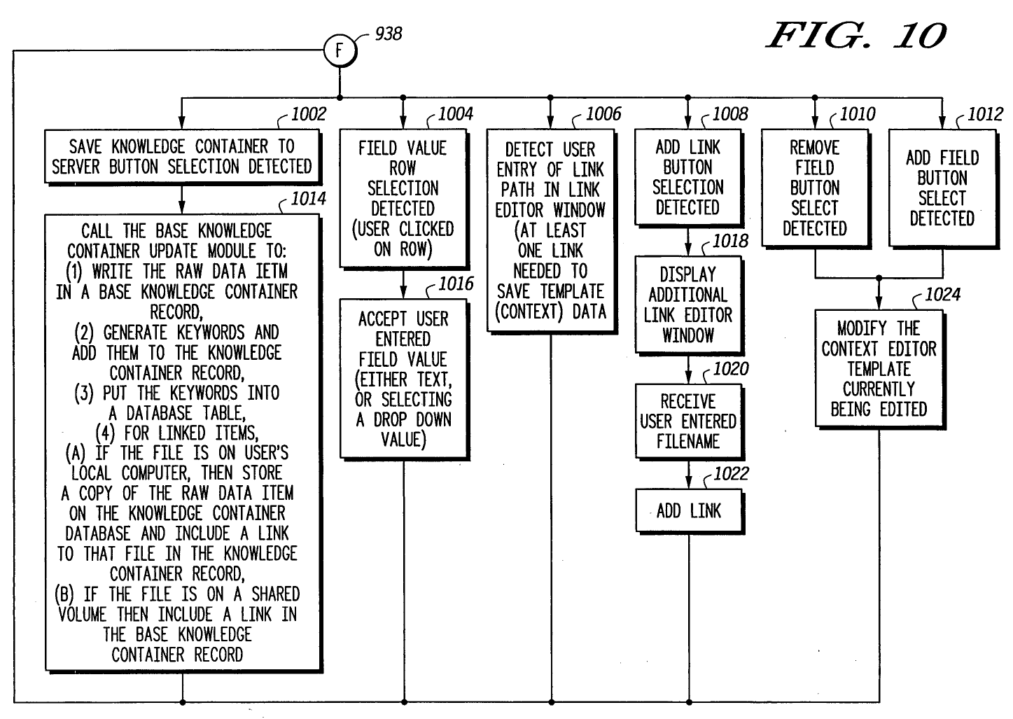

FIGS. 9 and 10 represent an example of a method of operation for the knowledge container creator module 118. Here, as shown in FIG. 9, a creator login is generated at step 902. Subsequent to step 902, in step 904, a context editor template is delayed with fields containing prefilled data and action buttons including “add field,” “remove selected fields,” “add link,” and “save knowledge container server.” In addition, at step 906, a knowledge creator client window is displayed including a default knowledge container name. Following step 906 is step 907 where a user selection of a knowledge container template type is detected. This selection is performed either as the default template type, from a drop down list, or where the user overrides the default template type with a new knowledge container name. Next, either step 908 occurs, where the override selection has been detected, or step 910 occurs, where either the defaults or drop down list selection was detected. Following step 908, is step 912 where a new knowledge container is created. Following either steps 910 or 912 is step 914 in which a context description editor template is provided which accepts default choices, user data field entries, and client station data or other non-user entered context descriptor information. After step 914, the system moves to step 904 described above. Following step 904 is step 938 (a transition step), also shown in FIG. 10.

As shown in FIG. 10, any one of six additional steps 1002, 1004, 1006, 1008, 1010 and 1012, occurs depending on input received from the user. Detection of the saved knowledge container to server selection occurs at step 1002. Detection of a field value row selection occurs at 1004. Detection of an entry of a link path in a link window occurs at step 1006. It should be noted that, in this embodiment, at least one link to a raw data item 110 needs to be saved. The detection of an add link request occurs at step 1008. The detection of a remove field request occurs at step 1008. Finally, detection of an add field request occurs at step 1012. The standard methods for directory browsing and file selection enable the user to specify the file or files to link to the knowledge container. In the current embodiment, these methods are reused from the Java Runtime Environment (JRE).

Following step 1002 discussed above, is step 1014 in which the knowledge container creator module 118 calls the base knowledge container update module 504 to perform the following: write the raw data item 110 to a base knowledge container record 700 file in a corresponding XML format, generate keywords and add the keywords to the base knowledge container record 700 in a corresponding XML format, place the keywords into a database table, and for linked items, if the raw data item 110 is on a user's local computer, a copy of the raw data item 110 is stored on the server knowledge container database 617, and a link to that raw data item 110 is stored in the base knowledge container record 700 and, if the file is on a shared volume, then a link thereto is stored in the base knowledge container record 700.

Next, following step 1004 discussed above, is step 1016. Here, a user entered field value is received via type written text or via a selection from a provided dropdown list. Following step 1008 discussed above, are steps 1018, 1020 and 1022. An additional link editor window is displayed in step 1018. At step 1020 a user entered file name is received. At step 1022 a link is added to the currently pending knowledge container item record. Following the steps 1010 and/or 1012 discussed above, the system modifies the context editor template, at step 1024, in a manner depending on which step 1008 or 1012 previously occurred (e.g., adding or removing a field). Next, following each of the steps 1014, 1016, 1006, 1022 and 1024 discussed above, the system returns to step 904 via transition step 938 where the context editor window is displayed.

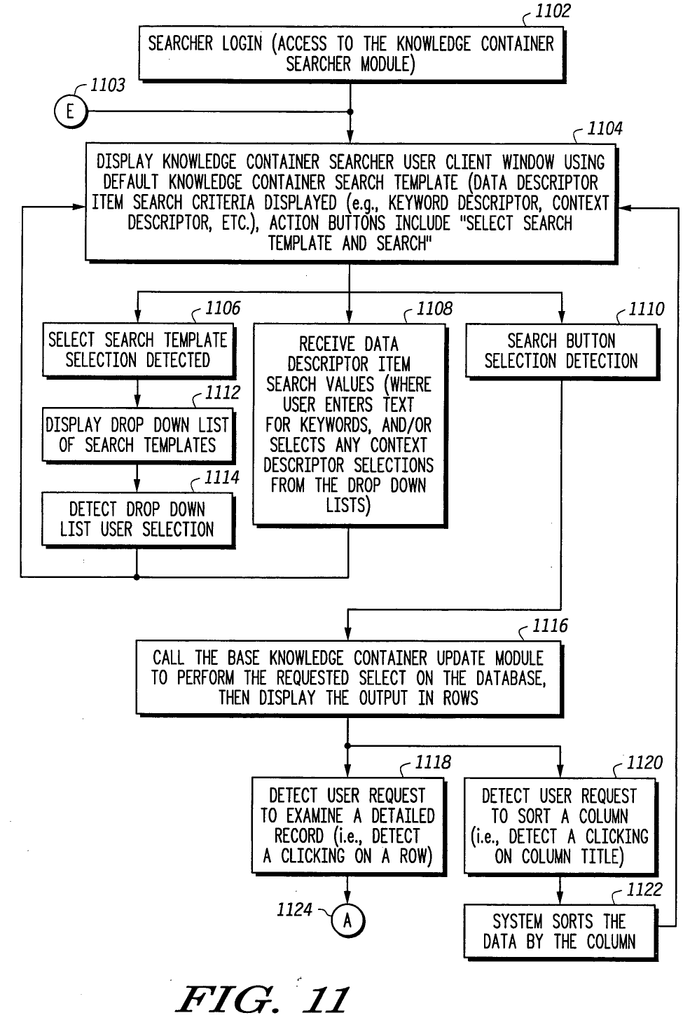

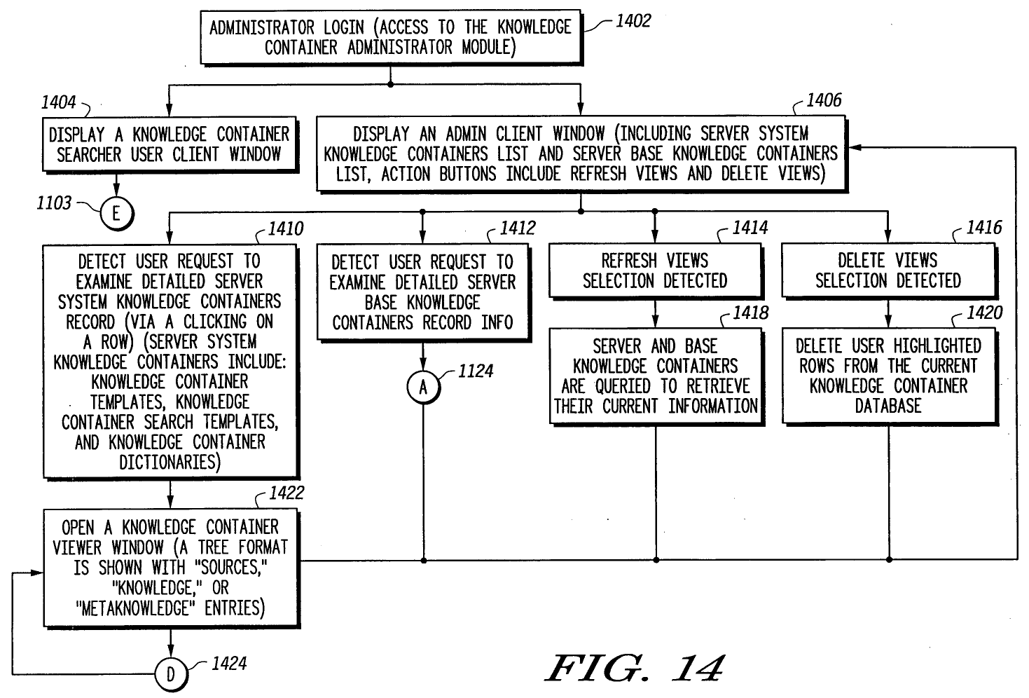

FIGS. 11, 12 and 13 show an example of a method of operation for the knowledge container searcher module 402. Here, the system logs in a searcher user at step 1102. In step 1104, a knowledge container searcher window is displayed using the default knowledge container search template 514 where search criteria is displayed to search data descriptor items 644, for example, a keyword descriptor 408 field, a context descriptor 412 field, or other data descriptor item search criteria. Action buttons are displayed indicating “select search template” and “search.” Alternatively, step 1104 instead follows step 1103 (a transition step) where step 1103 is associated with the method shown in FIG. 14 relating to knowledge container administrative module 302. After step 1104 (or step 1103) any one of three additional steps 1106, 1108 or 1110 follow. At step 1106 the select search template request is detected. At 1108 the entry of a data descriptor item search value is detected, for example, text for keywords, or a drop down list selection. At step 1110 a search button selection is detected. Following step 1106, as discussed above, are steps 1112 and 1114. A drop down list of search templates is displayed at step 1112. In step 1114, a user selection from the drop down list is detected. Following either steps 1114 or 1108, the system returns to the functionality described above relating to step 1104.

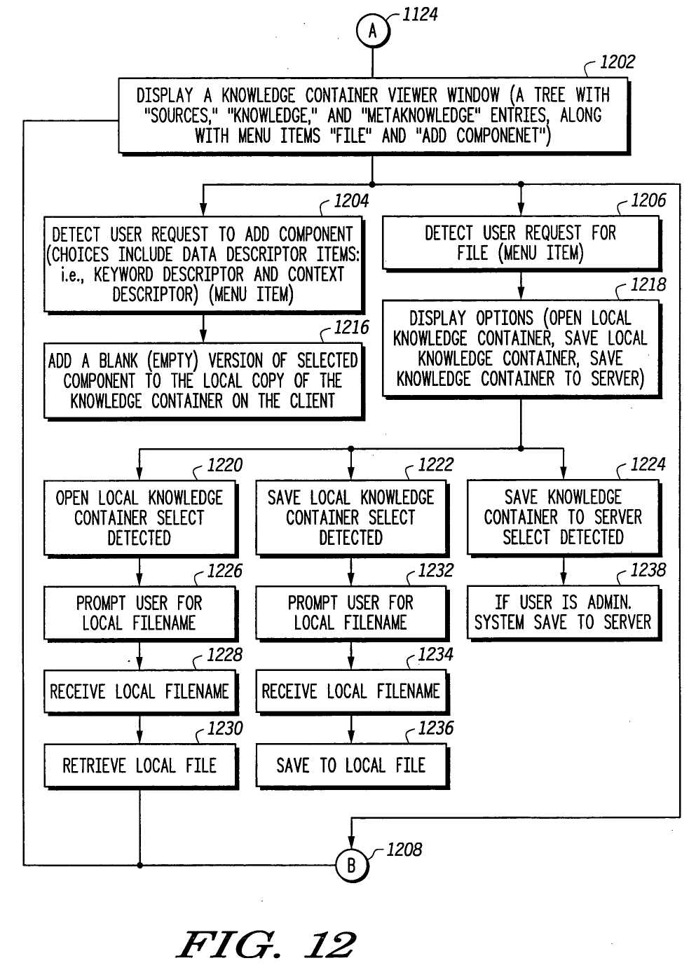

If a search button selection was detected in step 1110, the system proceeds to step 1116 where a call to the base knowledge container update module 504 is performed from the knowledge container searcher module 402 to perform the requested select on the knowledge container database 104 and the data management system software 110 and then displays the corresponding row of information from the corresponding data descriptor items 462. Following step 1116, depending on detected input, is either step 1118 or 1120. In step 1118, a user request to examine a detailed record is detected, for example, where a user double clicks on a row of data. In step 1120, the system detects a request to sort a column associated with the rows of data, for example, where the user clicks on a column title associated with the rows. Following step 1120, is step 1122. Here, the system sorts the rows of information by the requested column and the returns to the functionality of step 1104. Where a user request to examine a detailed record was detected in step 1118, the system then continues onto the functionality described in step 1202, and as shown in FIG. 12, via step 1124 (transition step).

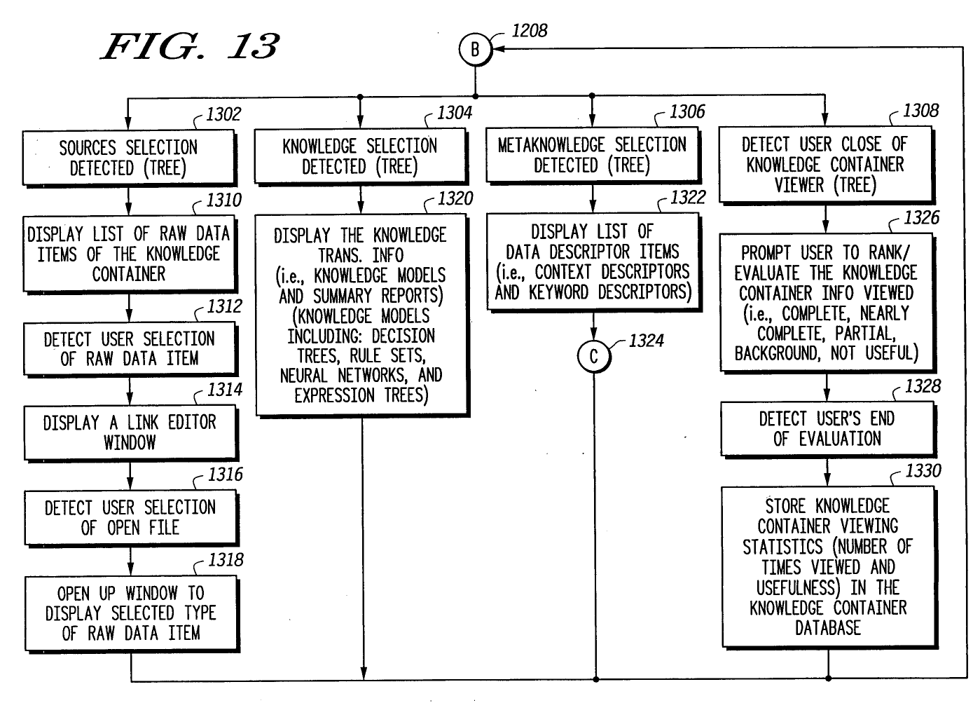

FIGS. 12 and 13 show an example of a method that executes upon the detection of a user request to examine a detailed knowledge container record. Here, following step 1124 is step 1202. Here a knowledge container viewer window is displayed showing a tree structure with the initial leaf items “sources,” “knowledge,” and “metaknowledge.” The menu items “file” and “add component” are also displayed After step 1202, any one of steps 1204, 1206 or 1208 follow. In step 1204 a user request to add a component is detected and the choices then presented to the user include: add data descriptor items 644 such as a keyword descriptor 408 and a context descriptor 412. Next is step 1216, where an empty version of the selected component is added to the local copy to the knowledge container on the client. Where step 1206 executes as discussed above, step 1218 then follows where the system displays the following options: “open local knowledge container,” “save local knowledge container,” and “save knowledge container to searcher.”

Following step 1218, and corresponding to the display options displayed therein, any one of the three steps, 1220, 1222 and 1224 then follow. In step 1220, an open local knowledge container selection is detected. Next is step 1222, where a save local knowledge container selection is detected. Step 1224 is performed when a save knowledge container to server selection is detected. Following step 1220 are three additional steps, 1226, 1228 and 1230. In step 1226, the system prompts the user for a local file name. In step 1228, the file name entered by the user is received. Following step 1228, is step 1230 where the local file is retrieved and the system returns to step 1202. Following step 1222 discussed above, three additional steps, 1232, 1234 and 1236 are performed. In step 1232, the user is prompted for a local file name. In step 1234, the local file entered by the user is received. Next, in step 1236, the knowledge container is saved to a local knowledge container database 616. Following step 1224 discussed above, in step 1238, the system saves the knowledge container to the server knowledge container database 617 where the user is deemed to have sufficient authorization for such updates.

Step 1208 (a transition step) is further shown on FIG. 13 and represents a transition from the functionality of step 1202, to the functionality of any one of four additional steps 1302, 1304, 1306 or 1308. In step 1302 the sources selection is detected, and following thereafter is a series of five sequential steps 1310, 1312, 1314, 1316 and 1318. In step 1310, a list of raw data items 110 of the currently selected knowledge container is displayed. Next, in step 1312, the system detects a user selection of a raw data item 110. In step 1314, a link editor window is displayed. In step 1316, a user request to open a file is detected. In step 1318, a window displaying the selected type of raw data item 110 is generated if the format of such file is known and can be displayed. For example, if the file opened is a .xls file, then the system will execute Microsoft Excel™ and open up the associated document in Microsoft Excel™. However, if the extension is, for example, xxx and such file is not known by the system to belong to any existing or known application, then such file is not opened. The current embodiment relies of the fact that the proper file associations have been specified in the operating system environment, e.g., associating .doc with WordPad, xls with MS Excel, etc. Other embodiments prompt the user for the software application with which to view the file linked to the knowledge container.

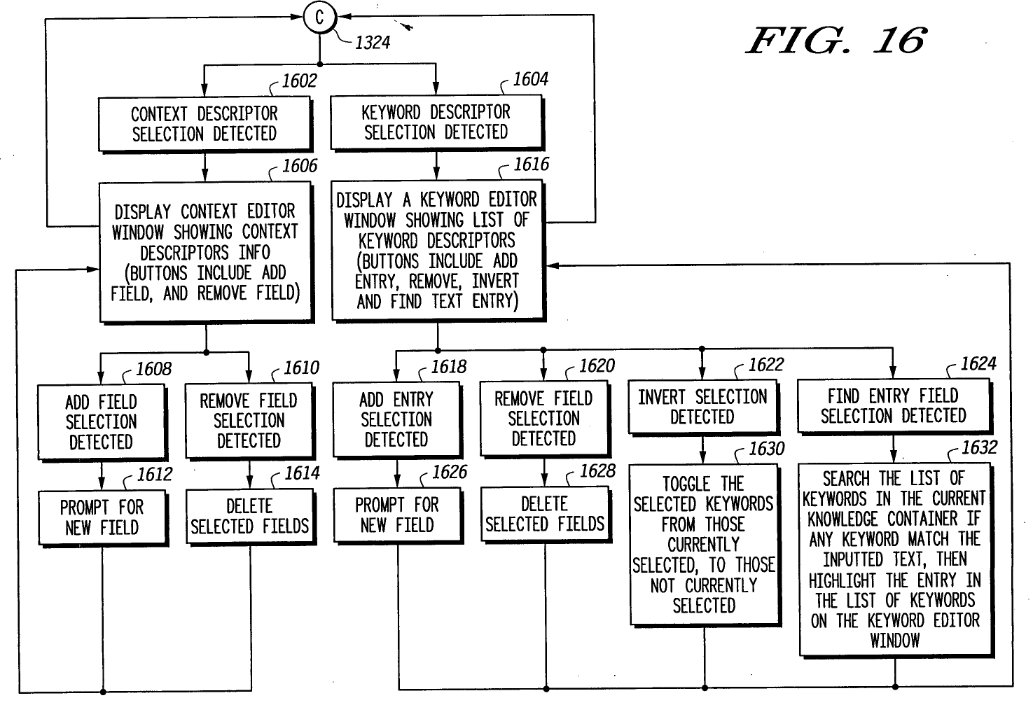

Step 1304 follows from step 1202, via step 1208, where the knowledge selection is detected. Following step 1304 is step 1320 the knowledge transformation information is displayed, for example, knowledge models 522 and summary reports 524 where knowledge models 522 include such things as decision trees 526, rule sets 528, neural networks 530 and expression trees 532. In step 1306 the selection of metaknowledge is detected. Following step 1306 are steps 1322 and 1324. In step 1322 a list of data descriptor items are displayed. In step 1324 (a transition step) the system continues on to execute a number of steps associated with modifying data descriptor item 644 information as further described in FIG. 16.

In step 1308 a request to close the knowledge container viewer is detected. Following step 1308 are steps 1326, 1328, 1330 and 1314. In step 1326, the user is prompted to rank or evaluate the knowledge container information they have just reviewed where such ranking criteria includes such things as “complete,” “nearly complete,” “partial,” “background,” and “not useful.” In step 1328, the completion of the evaluation ranking is detected. The knowledge container viewing statistics are stored at step 1330. The statistics stored include the number of times the knowledge container has been viewed and its useful ranking.

FIGS. 14, 15 and 16 show an example of a method associated with the knowledge container administrator module 302. Here, as shown in FIG. 14, the system logs in a user at step 1402. Following the step 1402, are both steps 1404 and 1406. In step 1404, a user client window is displayed. Following step 1404 is step 1103 (a transition step). In step 1406, a knowledge container administrator window is displayed including a list of server system knowledge containers 506 and a list of server based knowledge containers 508 and along with additional buttons allowing the user to request the refresh of and the use and deletion of views. Following step 1406 are steps 1410, 1412, 1414 and 1416. In step 1410, a user request is detected to examine a detailed server system knowledge container record. Here, such server system knowledge containers include knowledge container information such as template knowledge containers 512, search template knowledge containers 514 and dictionary knowledge containers 516.

In step 1412, a user request is detected to examine a detailed server based knowledge container record. After step 1412, is step 1124 (transition step). Step 1124 and those following thereafter are shown above in FIG. 12. In step 1414, a refresh views request is detected. Following step 1414, is step 1418 where the server system knowledge containers 506 and the server base knowledge containers 508 are queried to retrieve their current information for subsequent display in step 1406. Step 1416, detects a delete view selection. Following step 1416, is step 1420, where selected rows of the current knowledge container database are deleted.

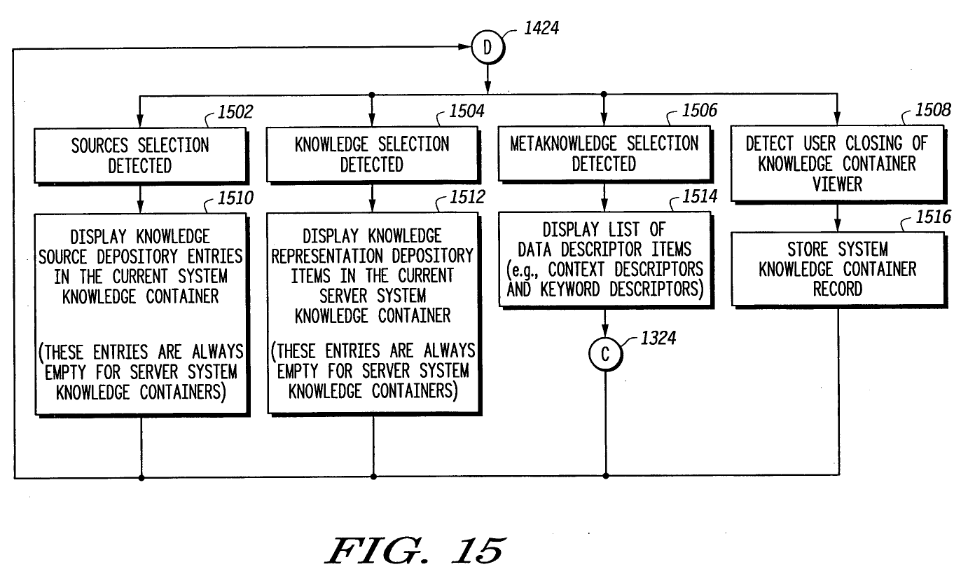

Continuing from step 1410 discussed above, is step 1422 where a knowledge container viewer window is displayed showing a tree format with leaves including “sources,” “knowledge,” and “metaknowledge.” Immediately following step 1422 is step 1424 (a transition step). As shown in FIG. 15, immediately following step 1422, are any one of four additional steps 1502, 1504, 1506 or 1508. A sources selection is detected at step 1502. Next, following 1502, is step 1510. In step 1510 knowledge source depository 626 entries are displayed from the current system knowledge container. However, since this depository of the knowledge container standard is not used for server system knowledge containers 506, i.e., the corresponding XML portion of the knowledge container is always empty and nothing is displayed corresponding to the knowledge source depository leaf. A detection of a knowledge selection occurs at step 1504. Following step 1504, is step 1512, the knowledge representation depository 628 items in the current server system knowledge container are displayed. However, since this depository section of the knowledge container standard is not used for a server system knowledge containers, i.e., the corresponding .XML portion of the knowledge container is always empty and nothing is displayed corresponding to the knowledge representation depository 628. A metaknowledge selection is detected in step 1514. The system displays a list of data descriptor items 512, 514 and 516 in step 1514. Following step 1536, is step 1324 (a transition step). Step 1324 is discussed in greater detail below with regard to FIG. 16. Finally, a user closing of the knowledge container view is detected in step 1508. Next, in step 1516, the system knowledge container record is stored.

FIG. 16 shows an example of a method associated with the viewing and editing of data description items 512, 514 and 516. The initial step is 1324 (a transition step) follows either step 1322 of FIG. 13 or step 1514 of FIG. 15. Following step 1354, are either one of two steps 1602 and 1604. Following step 1602 in which a context descriptor selection has been detected, a context window is displayed in step 1606 showing the context descriptor information in addition to the input buttons to receive user to request the adding of a field or removing of a field. Where a user selects to add or remove a field through the context editor, the system detects the request and then continues on to either steps 1608 or steps 1610 depending on whether the request was to add or remove a field. Either step 1612 or 1614 then follow where a prompt for a new field is generated or a selected field is deleted.

Following step 1604, where a keyword descriptor selection has been detected, is step 1616. A keyword editor window is displayed in step 1616 showing a list of keyword descriptors as well as displaying GUI buttons to the user “add entry,” “remove,” “invert” and “find text entry.” Following step 1616 are any one of four separate steps, including step 1618, 1620, 1622 and 1624. An added entry request is detected in step 1616. Immediately following step 1618 is step 1626, wherein a prompt for a new field is generated. A remove field request is detected in step 1620. Following step 1620 is step 1628. Here the selected field is deleted. An invert request is detected in step 1622. Following, in step 1630, the selected keywords are toggled from those currently selected to those currently not selected. Need to explain how this toggling is done. Finally, a find entry field request is detected in step 1624. Following, in step 1632, the list of keywords in the current knowledge container are searched and if any keyword matches the inputted text, then the entry is highlighted in the list of keywords.

FIG. 17 shows the knowledge container creator 1702, context editor 1704 and link editor 1706 as generated by the knowledge container creator module 118 and shown on display 106. The knowledge container creator module 118 generates these windows and receives input that allows the user to link raw data items to first and second data descriptor items 112 and 114. Knowledge container creator 1702 is generated and receives a knowledge container selection 1708. Knowledge container creator 1702 also is generated with a menu item “file” 1710.

The context editor 1704 includes action buttons 1712 and context descriptor 412 field names 1714 and values 1716. As described in FIG. 9, the action buttons 1712 include add field button 1718, remove selected fields button 1720, add link button 1722 and save knowledge container button 1724. The context descriptor 412 field names 1714 and field values 1716 are displayed with specific entries. The field configuration 1726 is displayed with a field value of phone body 1728 indicating that the user identified the corresponding as having a configuration 1726 of “a phone body” 1728. Next the field user 1730 is displayed with its contents “Bob Jones,” 1732 reflecting the fact that the base knowledge container record 700 was entered by Mr. Jones. The field department 1734 is displayed with a field value of “B500” 1736, indicating that Bob Jones was working in department B500 at the time of the creation of the record. The field location 1738 is displayed with a field value of “Flagstaff” 1740, indicating that Bob Jones was in Flagstaff when the initial record was created. Next, the product field 1742 is displayed with a field value of “X650” 1744 indicating that the phone body tested was associated with product X650 when tested.

The link editor 1706 is displayed with a link path input field 1750 and action buttons find file 1752 and open file 1754. The action buttons are used to locate and open raw data items 110. As links are added, additional link editors 1706 are also displayed on display 106.

FIG. 18 shows the knowledge container searcher 1802 being displayed on display 106 by knowledge container searcher module 402. The knowledge container searcher module 402 generates this windows and receives input which allows the user to search for the raw data item 110 through the contents of the first and second data descriptor items 112 and 114. The knowledge container searcher 1802 is shown containing search fields 1804 and associated field values 1806. The knowledge container searcher 1802 also contains search request input items 1808 and output search values 1810.

The search fields 1804 displayed on display 106 include the four context descriptor 412 fields configuration 1812, user 1814, department 1814 and product 1818 along with their corresponding values 1806 “All” 1820, “Bob Jones” 1822, “All” 1824 and “All” 1826. Each such value representing either a specifically requested value, e.g., “Bob Jones” 1822, or a catch-all value “All” 1820, 1824 and 1826. In addition, the knowledge container searcher 1802 also includes the display of a keyword descriptor 1828 in the form of a keyword, but no such keyword 1830 was received as input. As shown, the input received form the user would select all knowledge container items 700 containing a context descriptor 412 user field 1814 with a value of “Bob Jones” 1822.

The search request input items 1808 contain a search template value input 1832 and a search button 1834. When input is received in the search template value input 1832, the knowledge container searcher module 402 retrieves the associated search template and displays the corresponding format as search fields and default search values 1806. The module performs a search having the corresponding search fields 1804 and field values 1806 when input is detected from search button 1834.

Upon the detection of input from search button 1834 the output search values 1810 are displayed. As shown, various context descriptors 412, configuration 1836, user 1838, department 1840 and critique 1842 are displayed, as well as the corresponding values of each such descriptors 412, associated with each base knowledge container record 700, including the information in line 1844, 1846, 1848, 1850 and 1852. Because the only non-default input was “Bob Jones” 1822 in the user field 1814, all the entries displayed contain “Bob Jones” under the context descriptor 412 user 1838.

FIG. 19 shows the display of the knowledge container viewer 1902 whose operation was described above in FIGS. 5, 11 and 12. Here, the information being displayed is associated a server base knowledge container 508. The knowledge container viewer includes the display of two menu items 1904 and a tree 1906. The menu items are 1904 are input items file 1908 and add component 1910. Once selected they will execute as described above in FIG. 12. The tree 1906 is displayed indicating the associated knowledge container name 1912 and the information associated with the three depositories: knowledge source depository 632 (Sources node 1914), metaknowledge depository 634 (Knowledge node 1916) and knowledge representation depository (metaknowledge node 1918). The sources node 1914 shows corresponding leaves of first 1920 and second 1922 links 120 to the associated raw data items 110, as well as a link 120 to a third 1924 raw data item 110. As such, here, three separate data files are linked within a single base knowledge container record 700. As shown, there is no information in the knowledge node 1916 to be displayed. The metaknowledge node 1918 is shown to include both context descriptor 412 information 1926 and keyword descriptor 408 information 1928.

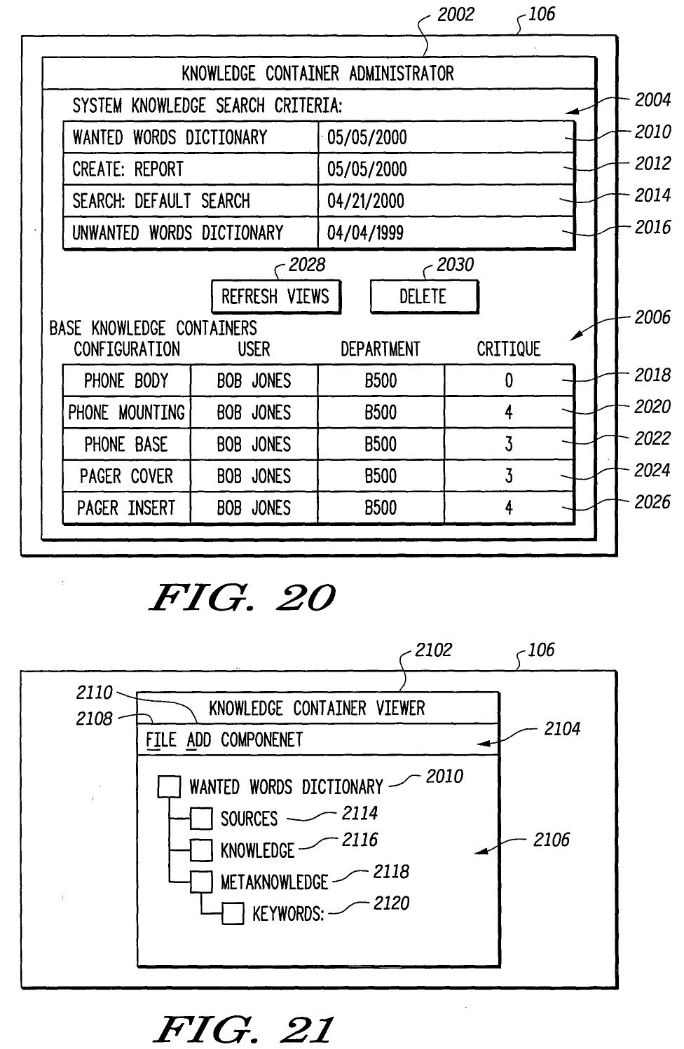

FIG. 20 shows the display of the knowledge container administrator 2002 whose operation was described above regarding FIGS. 14, 15 and 16. The knowledge container administrator is shown to include two different lists of information, one listing template descriptor items 2004 and the other listing base knowledge container record 700 field information 2006. The system enters an edit mode for template descriptor items 2004 when any of the template descriptor line items 2010, 2012, 2014 or 2016 is double clicked on. Similarly, the system enters an edit mode for base knowledge container record 700 fields 2018, 2020, 2022, 2024 and 2026. With the detection of the selection of any template descriptor item 2004 or base knowledge container record 700 field information 2006 when a delete button 2030 input is detected, then such selected item is deleted. A detection of an input from refresh button 2028 results in the refresh of the two lists 2004 and 2006.

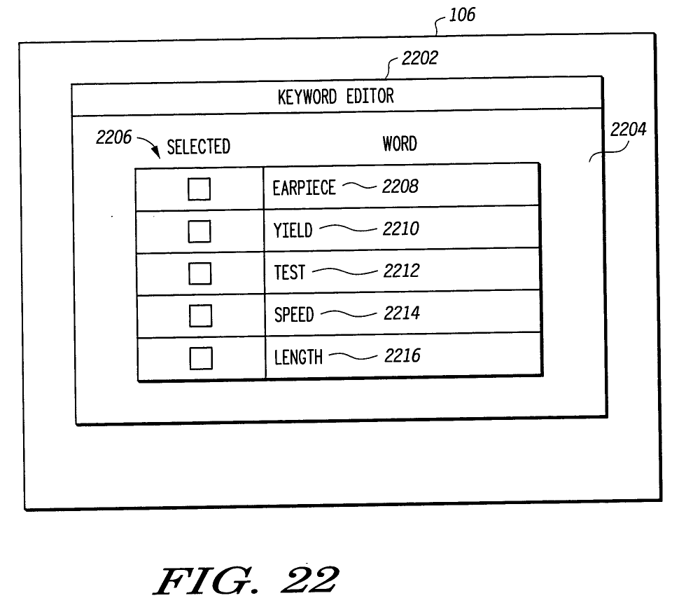

FIG. 21 shows the display of the knowledge container viewer 2102 whose operation was described above in FIG. 16. Here, the information being displayed is associated with a server system knowledge container 506. The knowledge container viewer includes the display of two menu items 2104 and a tree 2106. The menu items 2104 are input items file 2108 and add component 2110. Once selected they will execute as described above in FIGS. 14 and 15. Here, template descriptor item 2010 is detected as being chosen from FIG. 20. The tree 2106 is displayed indicating the template descriptor item 2010, or here, the wanted words dictionary. The system displays the title of the selected template descriptor item 2010 along with the three depositories: knowledge source depository 626 (Sources node 2114), metaknowledge depository 630 (Knowledge node 2116) and knowledge representation depository 628 (metaknowledge node 2118). The metaknowledge node 2118 is shown to include keyword descriptor 408 information 2120. If selection of the keywords descriptor 408 information 2120 is detected, the system generates the keyword editor window of FIG. 22.

FIG. 22 shows the display of the keyword editor 2202 whose operation was described above in FIG. 16. The keyword editor contains a list of keywords 2204. Any keyword can be removed from the list 2204 by the selection of the corresponding box in column 2206. The keyword editor 2202 is displayed for either the editing of the wanted words dictionary 2010 keyword descriptor 408 or the unwanted words dictionary 2016 keyword descriptor. In this example, the list of wanted keywords includes “earpiece” 2208, “yield” 2210, “test” 2212, “speed” 2214 and “length” 2216. In this embodiment, the wanted words dictionary 2010 and the wanted words dictionary 2010 is only updated via the knowledge container administrator module 302.

In one embodiment the base knowledge container update module 504 operates to update three separate database tables. A first table contains an XML version for each knowledge container along with its corresponding base knowledge container records 700 (note, as sued here, the term “record” refers to an association of data stored in separate tables, rather than a single record in a single table). A second table contains binary images of each of the raw data items 110 that were linked via links 470 to the corresponding data descriptor items 644, which are identified as belonging to a particular base knowledge container record 700. A third table contains data descriptor items 644 that are each separately identified as belonging to a particular knowledge container record 700.

This third table includes a list of keywords 408 that were generated for each knowledge container, and are identified by their corresponding base knowledge container records 700. Further, a list of context descriptors 412, associated with the particular base knowledge container record is also stored in the third table. In one embodiment the keywords 408 are generated by scanning both the text contained within context descriptor items 412 that have a free-form text format, as well as the contents of the corresponding raw data item 110. The keywords 408 are generated by processing the identified words as being in the wanted or unwanted keyword list as stored in the corresponding template descriptor item 304. In another embodiment, the same information is scanned, however, the ten most frequently used words not contained in the unwanted keyword list are identified. Other embodiments identify anywhere from seven to twenty of the most frequently used words not in the unwanted keyword list. Yet other embodiments identify a smaller or larger number of such words, but are believed to be less preferable than the other numbers mentioned above.

Although the examples above have been generally directed to managing data from test systems and their application in product design decisions, other embodiments may be directed to other data management systems that involve the association of raw data with descriptor information that does not involve test data. For example, one embodiment stores search reports that summarize the raw data of a variety of types. Another embodiment includes a template for “Lessons Learned” knowledge containers. Like the summary report 524, transformation information 306, “Lessons Learned” transformation information 306 provide a summary of the actionable knowledge that is deemed (by the person who submitted it to the database and/or by the system administrator) to be applicable to a specific scenario. Information, or metaknowledge, is included in the specific field of the lesson, e.g., customer support, and the impact of the lesson, e.g., on-time delivery. Here, rather than a product testing environment, we are in a customer support environment.

One major advantage of using this embodiment of the invention, rather than a simple frequently asked questions (FAQ) list or full-text searchable documentation, is that there is a flexible interface for capturing context descriptors 412 when the knowledge container is submitted to the database. Another advantage is that searches of the database of knowledge containers can use both context descriptors 412 and keywords selected from a set defined by the knowledge container administrator module 302, via a system administrator. Another advantage is the standard XML format, which is widely used, and therefore easily readable by a wide range of software systems. In general, the invention can be used for “Digital Assets Management”, such as for a library of video, audio, and text.

In one embodiment, the data management system software 116 includes functionality to allow administrator users to easily merge knowledge containers. Here, two or more Knowledge Containers Viewer windows 2102 are opened at the same time. Via point-and-click, the system detects an administrator user request, and selects one or more sections of the source knowledge containers(s), i.e., sources 2114, knowledge 2116, and metaknowledge 2118, and via a drag and drop command, adds them to a destination knowledge container and subsequently displays them in its structure tree 2106 in its Knowledge Containers Viewer window 2102.

In yet another embodiment, functionality allows for the encapsulation of one or more knowledge containers within a top-level knowledge container. This enables hierarchical construction of knowledge containers. This is implemented by allowing the selection of two or more knowledge containers by an administrative user from the list of available knowledge containers in the database, as displayed in block 1410 in FIG. 14, and the subsequent merging of the contents of the selected knowledge containers.

It should be understood that the implementation of other variations and modifications of the invention and its various aspects will be apparent to those of ordinary skill in the art, and that the invention is not limited by the specific embodiments described. For example, the steps described above may be carried out in any suitable order. It is therefore contemplated to cover by the present invention, and all modifications, variations, or equivalents that fall within the spirit and scope of the basic underlying principles disclosed and claimed herein.

1. A data management system comprising:
a knowledge container creator module operative to create at least a first data descriptor item and at least a second data descriptor item based upon a raw data item, capable of containing data representing raw data that is in one of a plurality of different formats, and to link the raw data item to at the least a first data descriptor item, and to link the raw data item to the at least a second data descriptor item.

2. The data management system of claim 1 wherein the first data descriptor item is in the form of a context descriptor, and wherein the second data descriptor item is in the form of at least one of the following: decision-support data descriptor, keyword descriptor and data access instructions descriptor.

3. A data management system comprising:
a knowledge container administrator module operative to modify a template descriptor item and operative to create knowledge transformation information by extrapolating data from a raw data item capable of containing data representing raw data that is in one of a plurality of different formats.

4. The data management system of claim 3 wherein the knowledge container administrator module is further operative to link the raw data item to the knowledge transformation information.

5. A data management system comprising:
a knowledge container creator module operative to link a raw data item that is in one of a plurality of different formats, to at least a first data descriptor item wherein the first data descriptor item is in the form of a context descriptor containing descriptive information about the raw data item, and wherein the knowledge container creator module is operative to link the raw data item to at least a second data descriptor item, wherein the second data descriptor item is in the form of at least one of:
a decision-support data descriptor, containing decision-support information generated from the raw data item,
a keyword descriptor, identifying keywords contained in the raw data item, and
a data access instructions descriptor, providing instructions on how to access the raw data in the raw data item; and
a knowledge container searcher module operative to retrieve the raw data item by searching at least one of: the first and second data descriptor items.

6. The data management system of claim 5 wherein the knowledge container creator module is operative to generate the first data descriptor item based upon the raw data item.

7. The data management system of claim 5 further comprising a base knowledge container update module that is operative to generate the second data descriptor item based upon the raw data item.

8. The data management system of claim 5 further comprising a base knowledge container update module that is operative to format the first and second data descriptor items in XML knowledge container format.

9. The data management system of claim 6 further comprising:
a knowledge container administrator module operative to modify a template descriptor item, for creating the first data descriptor item and for searching the first and second data descriptor items, wherein the template descriptor item includes at least one of:
template knowledge containers, for providing the inputs for entering the context descriptor,
search template knowledge containers, for providing the inputs for searching the data descriptor items, and
dictionary knowledge containers, for identifying keywords.

10. The data management system of claim 9 wherein modifying template descriptor item includes at least one of: adding fields, removing fields, adding keywords and removing keywords.

11. The data management system of claim 5 further comprising:
a knowledge container administrator module operative to create knowledge transformation information by extrapolating data from the raw data item and operative to link the raw data item to the knowledge transformation information.

12. The data management system of claim 11 wherein the knowledge container administrator module is operative to create a knowledge model using knowledge discovery techniques on the raw data item in the form of at least one of: decision trees, rule sets, neural networks and expression trees.

13. The data management system of claim 5 further comprising a base knowledge container update module that is operative to format the raw data item into a specific XML knowledge container format.

14. The data management system of claim 13 wherein the base knowledge container update module generates a keyword descriptor by processing the raw data item.

15. The data management system of claim 5 further comprising a knowledge container database operative to store the raw data item, the first data descriptor item, and the second data descriptor item.

16. The data management system of claim 15 wherein the base knowledge container comprises:
a knowledge source depository containing the raw data item; and
a metaknowledge depository containing the at least two data descriptor items associated with the raw data item.

17. The data management system of claim 15 wherein the base knowledge container further comprises a knowledge representation depository containing the knowledge transformation information generated from the raw data item.

18. The data management system of claim 17 wherein the knowledge transformation information is in the form of at least one of: knowledge model and summary report.

19. The data management system of claim 18 wherein the knowledge model is in the form of at least one of: decision trees, rule sets, neural networks and expression trees.

20. The data management system of claim 15 wherein the first and second data descriptor items are in the form of at least one of the following: decision-support data descriptor, keyword descriptor, context descriptor and data access instructions descriptor.

21. The data management system of claim 15 wherein the raw data item, the first descriptor item and the second descriptor item are stored in a XLM data blocks.

22. The data management system of claim 21 wherein the XML data blocks are defined by a data block definition with a form including at least one of: a table and a matrix.

23. A method for processing data comprising:
creating at least a first data descriptor item and at least a second data descriptor item based upon a raw data item, capable of containing data representing raw data that is in one of a plurality of different formats,
linking the raw data item to at the least a first data descriptor item, and
linking the raw data item to the at least a second data descriptor item.

24. The method of claim 23 further comprising:
creating the first and second descriptor items based upon the raw data item.

25. A computer readable medium containing programming instructions for processing data, the computer readable medium including programming instructions for:
linking a raw data item, capable of containing data representing raw data stored that is in one of a plurality of different formats, to at least a first data descriptor item wherein the first data descriptor item is in the form of a context descriptor, containing descriptive information about the raw data item,
linking the raw data item to at least a second data descriptor item, wherein the second data descriptor item is in the form of at least one of: an decision-support data descriptor, containing a decision-support information generated from the raw data, a keyword descriptor, identifying keywords contained in the raw data item, and a data access instructions descriptor, providing instructions on how to access the raw data in the raw data item; and
locating the raw data item by searching at least one of: the first and second data descriptor items.

26. The computer readable medium of claim 25 further containing programming instructions for:
generating knowledge transformation information by extrapolating data from the raw data item; and
creating the first and second data descriptor items based upon the raw data item.

27. A data management system comprising:
a knowledge container creator module operative to create at least a first data descriptor item and at least a second data descriptor item based upon the raw data item, capable of containing data representing raw data that is in one of a plurality of different formats, and to link a raw data item to at the least a first data descriptor item, and the knowledge container creator module operative to link the raw data item to the at least a second data descriptor item, wherein the second data descriptor item is in the form of at least one of:
a decision-support data descriptor, containing a decision-support information generated from the raw data;
a keyword descriptor, identifying keywords contained in the raw data item, and
a data access instructions descriptor, providing instructions on how to access the raw data in the raw data item; and
a knowledge container searcher module operative to retrieve the raw data item by searching at least one of: the first and second data descriptor items;
a knowledge container administrator module operative to modify template descriptor item for creating the first data descriptor item and for searching the first and second data descriptor items, wherein the template descriptor item includes at least one of:
template knowledge containers, for providing the inputs for entering the context descriptor,
search template knowledge containers, for providing the inputs for searching the data descriptor items, and
dictionary knowledge containers, for identifying keywords, and the knowledge container administrator module operative to create knowledge transformation information by extrapolating data from the raw data item and operative to link the raw data item to the knowledge transformation information; and
a base knowledge container update module operative to format the raw data item into an XML knowledge container format, and to generate a keyword descriptor by processing the raw data item;
a knowledge container database operative to store the raw data item, the first descriptor item and the second descriptor item and the knowledge container database further having:
a knowledge source depository containing the raw data item;
a metaknowledge depository containing the data descriptor item associated with the raw data item; and
a knowledge representation depository containing the knowledge transformation information generated from the raw data item.
